(19) United States
(12) Patent Application Publication
(10) Pub. No.: US 2024/0030413 A1
(43) Pub. Date: Jan. 25, 2024

(54) POSITIVE ELECTRODE, METHOD FOR FORMING POSITIVE ELECTRODE, SECONDARY BATTERY, ELECTRONIC DEVICE, POWER STORAGE SYSTEM, AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP); Shuhei YOSHITOMI, Ayase, Kanagawa (JP); Atsushi KAWATSUKI, Atsugi, Kanagawa (JP)

(21) Appl. No.: 18/256,478

(22) PCT Filed: Nov. 29, 2021
(86) PCT No.: PCT/IB2021/061037

§ 371 Date: Jun. 8, 2023

(30) Foreign Application Priority Data
Dec. 11, 2020 (JP) 2020-205588
Feb. 26, 2021 (JP) 2021-029861

(51) Int. Cl. H01M 4/36; H01M 4/04; H01M 4/485; H01M 4/62; H01M 4/525; H01M 4/58; H01M 4/1315; H01G 11/46; H01G 11/86

(52) U.S. Cl. CPC H01M 4/366; H01M 4/0471; H01M 4/0404; H01M 4/485; H01M 4/625; H01M 4/525; H01M 4/5825; H01M 4/1315; H01G 11/46; H01G 11/86; H01M 2004/028

(57) ABSTRACT

A positive electrode and a secondary battery with little deterioration due to charge and discharge are provided. A positive electrode and a secondary battery with high electrode density are provided. Alternatively, a positive electrode and a secondary battery with excellent rate characteristics are provided. The positive electrode contains a positive electrode active material and a coating material. The coating material covers at least part of a surface of the positive electrode active material, and the positive electrode active material contains lithium cobalt oxide containing magnesium, fluorine, aluminum, and nickel. The lithium cobalt oxide includes a region with the highest concentration of one or more selected from the magnesium, the fluorine, and the aluminum in a surface portion. The coating material is preferably one or more selected from glass, carbon black, graphene, and a graphene compound.

### TECHNICAL FIELD

The present invention relates to a method for forming a positive electrode active material. Another embodiment of the present invention relates a method for forming a positive electrode. Another embodiment of the present invention relates a method for forming a secondary battery. Another embodiment of the present invention relates to a positive electrode active material; a positive electrode; a secondary battery; and a portable information terminal, a power storage system, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that one embodiment of the present invention particularly relates to a method for forming a positive electrode active material or the positive electrode active material. Alternatively, one embodiment of the present invention particularly relates to a method for forming a positive electrode or the positive electrode. Alternatively, one embodiment of the present invention particularly relates to a method for forming a secondary battery or the secondary battery.

Note that semiconductor devices in this specification mean all devices that can function by utilizing semiconductor characteristics, and an electro-optical device, a semiconductor circuit, and an electronic device are all semiconductor devices.

Note that electronic devices in this specification mean all devices including positive electrode active materials, secondary batteries, or power storage devices, and electro-optical devices including positive electrode active materials, positive electrodes, secondary batteries, or power storage devices, information terminal devices including power storage devices, and the like are all electronic devices.

Note that in this specification and the like, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, home power storage systems, industrial power storage systems, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Above all, composite oxides having a layered rock salt structure, such as lithium cobalt oxide and lithium nickel-cobalt-manganese oxide, are widely used. These materials have characteristics of high capacity and high discharge voltage, which are useful for active materials for power storage devices; to exhibit high capacity, a positive electride is exposed to a high potential versus a lithium potential at the time of charge. In such a high potential state, release of a large amount of lithium might cause a reduction in stability of the crystal structure to cause significant deterioration in charge and discharge cycles. In the aforementioned background, improvements of positive electrode active materials included in positive electrodes of secondary batteries are actively conducted so as to achieve highly stable secondary batteries with high capacity (e.g., Patent Document 1 to Patent Document 3).

### REFERENCES

### Patent Documents

[Patent Document 1] Japanese Published Patent Application No. 2018-088400
[Patent Document 2] International Publication No. WO2018/203168 Pamphlet
[Patent Document 3] Japanese Published Patent Application No. 2020-140954

### SUMMARY OF THE INVENTION

### Problems to be Solved by the Invention

In spite of the active improvements of positive active materials conducted in Patent Documents 1 to 3, development of lithium-ion secondary batteries and positive electrode active materials used therein has room for improvement in terms of charge and discharge capacity, cycle performance, reliability, safety, cost, and the like.

In view of the above, an object of one embodiment of the present invention is to provide a positive electrode active material that is stable in a high potential state and/or a high temperature state. Another object is to provide a positive electrode active material whose crystal structure is not easily broken even when charge and discharge are repeated. Another object is to provide a positive electrode active material with excellent charge and discharge cycle performance. Another object is to provide a positive electrode active material with high charge and discharge capacity. Another object is to provide a highly reliable or safe secondary battery.

An object of one embodiment of the present invention is to provide a positive electrode that is stable in a high potential state and/or a high temperature state. Another object is to provide a positive electrode with excellent charge and discharge cycle performance. Another object is to provide a positive electrode that can increase the charge and discharge rate. Another object is to provide a highly reliable or safe secondary battery.

In view of the above, an object of one embodiment of the present invention is to provide a method for forming a positive electrode active material that is stable in a high potential state and/or a high temperature state. Another object is to provide a method for forming a positive electrode active material whose crystal structure is not easily broken even when charge and discharge are repeated. Another object is to provide a method for forming a positive electrode active material with excellent charge and discharge cycle performance. Another object is to provide a method for forming a positive electrode active material with high charge and discharge capacity. Another object is to provide a method for forming a highly reliable or safe secondary battery.

An object of one embodiment of the present invention is to provide a method for forming a positive electrode that is stable in a high potential state and/or a high temperature state. Another object is to provide a method for forming a positive electrode with excellent charge and discharge cycle performance. Another object is to provide a method for forming a positive electrode that can increase the charge and discharge rate. Another object is to provide a method for forming a highly reliable or safe secondary battery.

Another object of one embodiment of the present invention is to provide a novel material, novel active material particles, a novel electrode, a novel secondary battery, a novel power storage device, or a formation method thereof. Another object of one embodiment of the present invention is to provide a method for forming a secondary battery having one or more of characteristics selected from increased purity, improved performance, and increased reliability or to provide the secondary battery.

Note that the description of these objects does not preclude the existence of other objects. Note that one embodiment of the present invention does not have to achieve all the objects. Other objects can be derived from the description of the specification, the drawings, and the claims.

### Means for Solving the Problems

One embodiment of the present invention is a positive electrode including a first active material, a second active material, and glass. At least part of a surface of the first active material includes a region covered with the glass, and at least part of a surface of the glass includes a region covered with the second active material. The first active material includes a first composite oxide represented by LiM1O₂ (M1 is one or more selected from Fe, Ni, Co, and Mn). The second active material includes a second composite oxide represented by LiM2PO₄ (M2 is one or more selected from Fe, Ni, Co, and Mn). The glass has lithium-ion conductivity.

Another embodiment of the present invention is a positive electrode including a first active material, a second active material, and glass. At least part of a surface of the first active material includes a region covered with the glass and the second active material. The first active material includes a first composite oxide represented by LiM1O₂ (Mb is one or more selected from Fe, Ni, Co, and Mn). The second active material includes a second composite oxide represented by LiM2PO₄ (M2 is one or more selected from Fe, Ni, Co, and Mn). The glass has lithium-ion conductivity.

Another embodiment of the present invention is a positive electrode including a first active material, a second active material, glass, and a conductive material. At least part of a surface of the first active material includes a region covered with the glass, and at least part of a surface of the glass includes a region covered with the second active material and the conductive material. The first active material includes a first composite oxide represented by LiM1O₂ (Mb is one or more selected from Fe, Ni, Co, and Mn). The second active material includes a second composite oxide represented by LiM2PO₄ (M2 is one or more selected from Fe, Ni, Co, and Mn). The glass has lithium-ion conductivity. The conductive material contains a graphene compound or carbon nanotube.

Another embodiment of the present invention is a positive electrode including a first active material, a second active material, glass, and a conductive material. At least part of a surface of the first active material includes a region covered with the glass, the second active material, and the conductive material. The first active material includes a first composite oxide represented by LiM1O₂ (M1 is one or more selected from Fe, Ni, Co, and Mn). The second active material includes a second composite oxide represented by LiM2PO₄ (M2 is one or more selected from Fe, Ni, Co, and Mn). The glass has lithium-ion conductivity. The conductive material contains a graphene compound or carbon nanotube.

In the positive electrode described in any one of the above, the first active material preferably includes lithium cobalt oxide containing magnesium, fluorine, aluminum, and nickel, and the lithium cobalt oxide preferably includes a region with the highest concentration of any one or more selected from the magnesium, the fluorine, and the aluminum in a surface portion.

Another embodiment of the present invention is a positive electrode including a positive electrode active material and a conductive material. At least part of a surface of the positive electrode active material is covered with the conductive material. The positive electrode active material includes lithium cobalt oxide containing magnesium, fluorine, aluminum, and nickel. The lithium cobalt oxide includes a region with the highest concentration of any one or more selected from the magnesium, the fluorine, and the aluminum in a surface portion. The conductive material contains carbon.

Another embodiment of the present invention is a positive electrode including a positive electrode active material and a conductive material. At least part of a surface of the positive electrode active material is covered with the conductive material. The positive electrode active material includes lithium nickel-manganese-cobalt oxide containing one or more selected from calcium, fluorine, aluminum, and gallium. The lithium nickel-manganese-cobalt oxide includes a region with the highest concentration of any one or more selected from the calcium, the fluorine, the aluminum, and the gallium in a surface portion. The conductive material contains carbon.

In the positive electrode described in any one of the above, it is preferable that the conductive material include one or more selected from carbon black, graphene, and a graphene compound.

Another embodiment of the present invention is a secondary battery including the positive electrode described in any one of the above.

Another embodiment of the present invention is a transport vehicle including the above-described secondary battery.

Another embodiment of the present invention is a power storage system including the above-described secondary battery.

Another embodiment of the present invention is an electronic device including the above-described secondary battery.

Another embodiment of the present invention is a method for forming a positive electrode by performing a composing process of lithium cobalt oxide containing magnesium, fluorine, aluminum, and nickel and acetylene black to form a positive electrode active material composite, mixing the positive electrode active material composite, a binder, and a solvent to form a slurry, applying the slurry to a positive electrode current collector to form an electrode layer, and pressing the electrode layer.

Another embodiment of the present invention is a method for forming a positive electrode by mixing lithium cobalt oxide containing magnesium, fluorine, aluminum, and nickel, graphene oxide, a binder, and a solvent to form a slurry, applying the slurry to a positive electrode current collector to form an electrode layer, and subjecting the electrode layer to chemical reduction and thermal reduction.

In the method for forming a positive electrode described in any of the above, the chemical reduction is preferably a step of immersing the electrode layer in an ascorbic acid aqueous solution, and the thermal reduction is preferably a step of heating the electrode layer at higher than or equal to 125° C. and lower than or equal to 200° C.

### Effect of the Invention

In view of the above, one embodiment of the present invention can provide a positive electrode active material that is stable in a high potential state and/or a high temperature state. Alternatively, a positive electrode active material whose crystal structure is not easily broken even when charge and discharge are repeated can be provided. Alternatively, a positive electrode active material with excellent charge and discharge cycle performance can be provided. Alternatively, a positive electrode active material with high charge and discharge capacity can be provided. Alternatively, a highly reliable or safe secondary battery can be provided.

Another embodiment of the present invention can provide a positive electrode that is stable in a high potential state and/or a high temperature state. Alternatively, a positive electrode with excellent charge and discharge cycle performance can be provided. Alternatively, a positive electrode that can increase the charge and discharge rate. Alternatively, a highly reliable or safe secondary battery can be provided.

According to one embodiment of the present invention, a method for forming a positive electrode active material that is stable in a high potential state and/or a high temperature state can be provided. Alternatively, a method for forming a positive electrode active material whose crystal structure is not easily broken even when charge and discharge are repeated can be provided. Alternatively, a method for forming a positive electrode active material with excellent charge and discharge cycle performance can be provided. Alternatively, a method for forming a positive electrode active material with high charge and discharge capacity can be provided. Alternatively, a method for forming a highly reliable or safe secondary battery can be provided.

Another embodiment of the present invention can provide a method for forming a positive electrode that is stable in a high potential state and/or a high temperature state. Alternatively, a method for forming a positive electrode with excellent charge and discharge cycle performance can be provided. Alternatively, a method for forming a positive electrode that can increase the charge and discharge rate. Alternatively, a method for forming a highly reliable or safe secondary battery can be provided.

According to one embodiment of the present invention, a novel material, novel active material particles, a novel secondary battery, a novel power storage device, or a formation method thereof can be provided. According to one embodiment of the present invention, a method for forming a secondary battery having one or more of characteristics selected from increased purity, improved performance, and increased reliability or to provide the secondary battery can be provided.

Note that the description of these effects does not preclude the existence of other effects. Note that one embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a diagram illustrating a cross-sectional structure of a positive electrode of one embodiment of the present invention.

FIG. 2A1 to FIG. 2B2 are diagrams each illustrating a cross-sectional structure of a positive electrode active material composite of one embodiment of the present invention.

FIG. 3A1 to FIG. 3B2 are diagrams each illustrating a cross-sectional structure of a positive electrode active material composite of one embodiment of the present invention.

FIG. 4A1 to FIG. 4B2 are diagrams each illustrating a cross-sectional structure of a positive electrode active material composite of one embodiment of the present invention.

FIG. 5A and FIG. 5B are diagrams showing a method for forming a positive electrode active material composite of one embodiment of the present invention.

FIG. 6A and FIG. 6B are diagrams showing a method for forming a positive electrode active material composite of one embodiment of the present invention.

FIG. 7A and FIG. 7B are diagrams showing methods for forming a positive electrode active material composite of one embodiment of the present invention.

FIG. 8A is a top view of a positive electrode active material of one embodiment of the present invention, and FIG. 8B and FIG. 8C are cross-sectional views of the positive electrode active material of one embodiment of the present invention.

FIG. 9 is a diagram illustrating crystal structures of a positive electrode active material of one embodiment of the present invention.

FIG. 10 shows XRD patterns calculated from crystal structures.

FIG. 11 is a diagram illustrating crystal structures of a positive electrode active material of a comparative example.

FIG. 12 shows XRD patterns calculated from crystal structures.

FIG. 13 is an example of a TEM image showing orientations of crystals substantially aligned with each other.

FIG. 14A is an example of a STEM image showing crystal orientations substantially aligned with each other. FIG. 14B shows FFT of a region of a rock-salt crystal RS, and FIG. 14C shows FFT of a layered rock-salt crystal LRS.

FIG. 15A to FIG. 15C are diagrams showing methods for forming a positive electrode active material.

FIG. 16 is a diagram showing a method for forming a positive electrode active material.

FIG. 17A to FIG. 17C are diagrams showing methods for forming a positive electrode active material.

FIG. 18A is an exploded perspective view of a coin-type secondary battery, FIG. 18B is a perspective view of the coin-type secondary battery, and FIG. 18C is a cross-sectional perspective view thereof.

FIG. 19A illustrates an example of a cylindrical secondary battery. FIG. 19B illustrates an example of a cylindrical secondary battery. FIG. 19C illustrates an example of a plurality of cylindrical secondary batteries. FIG. 19D illustrates an example of a power storage system including a plurality of cylindrical secondary batteries.

FIG. 20A and FIG. 20B are diagrams illustrating examples of a secondary battery, and FIG. 20C is a diagram illustrating the internal state of the secondary battery.

FIG. 21A to FIG. 21C are diagrams illustrating an example of a secondary battery.

FIG. 22A and FIG. 22B are external views of a secondary battery.

FIG. 23A to FIG. 23C are diagrams illustrating a method for forming a secondary battery.

FIG. 24A to FIG. 24C are diagrams illustrating structure examples of a battery pack.

FIG. 25A and FIG. 25B are diagrams illustrating examples of a secondary battery.

FIG. 26A to FIG. 26C are diagrams illustrating an example of a secondary battery.

FIG. 27A and FIG. 27B are diagrams illustrating examples of a secondary battery.

FIG. 28A is a perspective view of a battery pack of one embodiment of the present invention, FIG. 28B is a block diagram of a battery pack, and FIG. 28C is a block diagram of a vehicle including a motor.

FIG. 29A to FIG. 29D are diagrams illustrating examples of transport vehicles.

FIG. 30A and FIG. 30B are diagrams illustrating power storage devices of one embodiment of the present invention.

FIG. 31A is a diagram illustrating an electric bicycle, FIG. 31B is a diagram illustrating a secondary battery of the electric bicycle, and FIG. 31C is a diagram illustrating an electric motorcycle.

FIG. 32A to FIG. 32D are diagrams illustrating examples of electronic devices.

FIG. 33A illustrates examples of wearable devices, FIG. 33B is a perspective view of a watch-type device, and FIG. 33C is a diagram illustrating a side surface of the watch-type device. FIG. 33D is a diagram illustrating an example of wireless earphones.

FIG. 34A is a surface SEM image of a positive electrode active material composite in Example 1.

FIG. 34B is a surface SEM image of lithium cobalt oxide in Example 1.

FIG. 35 is a graph showing the electrode density of positive electrodes in Example 1.

FIG. 36 is a surface SEM image of a positive electrode active material composite in Example 2.

FIG. 37A is a graph showing charge characteristics of secondary batteries in Example 2. FIG. 37B is a graph showing discharge characteristics of the secondary batteries in Example 2.

FIG. 38 is a graph showing cycle performance of the secondary batteries in Example 2.

### MODE FOR CARRYING OUT THE INVENTION

Embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly include a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably includes a composition. In this specification and the like, the positive electrode active material of one embodiment of the present invention preferably includes a composite.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

Particle diameters can be measured by laser diffraction particle distribution and can be compared by the numerical values of D50. Here, D50 is a particle diameter when the accumulated amount of particles accounts for 50% of an accumulated particle amount curve which is the result of the particle size distribution measurement. Measurement of the size of a particle is not limited to laser diffraction particle distribution measurement; in the case where the size is less than or equal to the lower measurement limit of laser diffraction particle distribution measurement, the major axis of a cross section of the particle may be measured by analysis with a SEM (Scanning Electron Microscope), a TEM (Transmission Electron Microscope), or the like.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing − (a minus sign) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. As the Miller indices of trigonal system and hexagonal system such as R−3m, not only (hkl) but also (hkil) are used in some cases. Here, i is −(h+k).

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist in part of the crystal structure.

In this specification and the like, the theoretical capacity of a positive electrode active material refers to the amount of electricity for the case where all the lithium that can be inserted into and extracted from the positive electrode active material is extracted. For example, the theoretical capacity of LiFePO₄ is 170 mAh/g, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂ or LiₓMO₂. In this specification, LiₓCoO₂ can be replaced with LiₓMO₂ as appropriate. It can be said that x is an occupancy rate, and in the case of a positive electrode active material in a secondary battery, x may be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x≤0.24.

In the case where lithium cobalt oxide almost satisfies the stoichiometric composition proportion, lithium cobalt oxide is LiCoO₂ and the occupancy rate of Li in the lithium sites is x=1. For a secondary battery after its discharge ends, it can be said that lithium cobalt oxide is LiCoO₂ and x=1. Here, “discharging ends” means that a voltage becomes lower than or equal to 2.5 V (lithium counter electrode) at a current of 100 mA/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary battery. At this time, it can be said that the discharge is terminated. In general, in a lithium-ion secondary battery using LiCoO₂, the discharge voltage rapidly decreases until discharge voltage reaches 2.5 V; thus, discharge is terminated under the above-described conditions.

In this specification and the like, the charge depth obtained when all the lithium that can be inserted into and extracted from a positive electrode material is inserted is 0, and the charge depth obtained when all the lithium that can be inserted into and extracted from the positive electrode active material is extracted is 1, in some cases.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charge and discharge and excellent cycle performance, are not affected by the material of the negative electrode. For example, the secondary battery of one embodiment of the present invention using a lithium counter electrode is charged and discharged at a relatively high charge voltage of 4.6 V in some cases; however, charge and discharge may be performed at a lower voltage. Charge and discharge at a lower voltage will result in cycle performance better than that described in this specification and the like.

In this specification and the like, the term “kiln” refers to an apparatus for heating an object. Instead of the kiln, the term “furnace”, “stove”, or “heating apparatus” may be used, for example.

### Embodiment 1

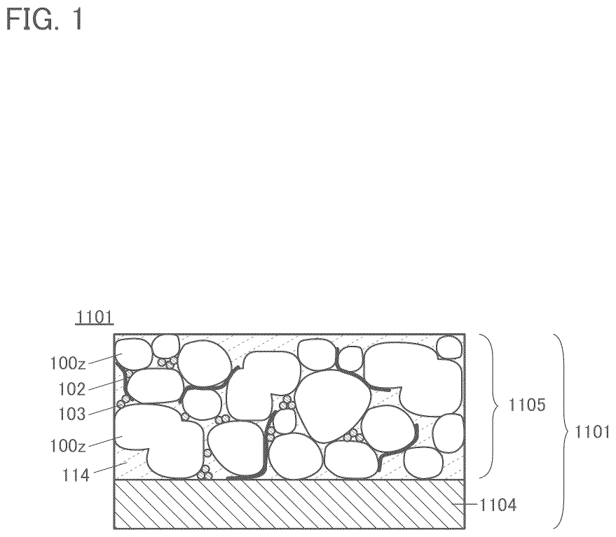

In this embodiment, a positive electrode, a positive electrode active material composite, and a method for forming the positive electrode active material composite which are embodiments of the present invention are described with reference to FIG. 1 to FIG. 7.

A positive electrode 1101 includes a positive electrode active material layer 1105 and a positive electrode current collector 1104. The positive electrode active material layer 1105 includes a positive electrode active material composite 100z including a first active material 100x functioning as a positive electrode active material and a coating material 101 covering at least part of the first active material 100x, and may further include a conductive material and a binder.

Alternatively, the positive electrode active material layer 1105 includes the positive electrode active material composite 100z including the first active material 100x functioning as a positive electrode active material and a second active material 100y in contact with the first active material 100x with the coating material 101 covering at least part of the first active material 100x therebetween, and may further include a conductive material and a binder.

Note that the density of the positive electrode active material layer 1105 is preferably higher than or equal to 3.0 g/cm³, further preferably higher than or equal to 3.5 g/cm³, still further preferably higher than or equal to 3.8 g/cm³. Thus, pressing treatment may be performed to increase the density of the positive electrode active material layer 1105. Note that in the case of performing pressing treatment, conditions of the pressing treatment are desirably set as appropriate so as not to lose structures of the first active material 100x and the positive electrode active material composite 100z described later.

The positive electrode active material composite 100z can be obtained by a composing process, which will be described later, with the use of at least the first active material 100x and the coating material 101. As the composing process, at least one or more of the following composing processes can be used: a composing process using mechanical energy, e.g., a mechanochemical method, a mechanofusion method, or a ball mill method; a composing process using a liquid phase reaction, e.g., wet mixing, spray drying, a coprecipitation method, a hydrothermal method, or a sol-gel method; and a composing process using a gas phase reaction, e.g., a barrel sputtering method, an ALD (Atomic Layer Deposition) method, an evaporation method, or a CVD (Chemical Vapor Deposition) method. Heat treatment is preferably performed once or more times in the composing process. Note that a composing process in this specification is sometimes referred to as a surface coating process or a coating process. A specific method for forming the positive electrode active material composite 100z will be described later.

The positive electrode active material composite 100z can also be obtained by a composing process with the use of the second active material 100y in addition to the first active material 100x and the coating material 101. As the composing process, at least one or more of the following composing processes can be used: a composing process using mechanical energy, e.g., a mechanochemical method, a mechanofusion method, or a ball mill method; a composing process using a liquid phase reaction, e.g., wet mixing, spray drying, a coprecipitation method, a hydrothermal method, or a sol-gel method; and a composing process using a gas phase reaction, e.g., a barrel sputtering method, an ALD method, an evaporation method, or a CVD method. Heat treatment is preferably performed once or more times in the composing process. A specific method for forming the positive electrode active material composite 100z will be described later.

FIG. 1 illustrates an example of the positive electrode 1101 of one embodiment of the present invention. The positive electrode 1101 includes the positive electrode current collector 1104 and the positive electrode active material layer 1105. The positive electrode active material layer 1105 includes the positive electrode active material composite 100z. The positive electrode active material composite 100z includes the coating material 101 and the first active material 100x capable of occluding and releasing carrier ions. Specific examples of the first active material 100x and the coating material 101 will be described later.

Although FIG. 1 illustrates an example in which a graphene compound 102 and carbon black 103 are used as the conductive material, the conductive material is not necessarily used in the positive electrode active material layer 1105 when the positive electrode active material composite 100z has sufficient electron conductivity. The kind of conductive material is not limited to the example illustrated in FIG. 1, and only a graphene compound, carbon black, or carbon fiber such as carbon nanotube may be used, or carbon fiber such as carbon nanotube and carbon black may be used in combination. That is, as the conductive material, a material containing carbon is suitably used. Note that although not illustrated in FIG. 1, the positive electrode active material layer 1105 preferably includes a binder. As the binder, a high molecular material such as polyvinylidene fluoride and a molecular crystalline electrolyte such as Li(FSI)(SN)₂ can be used.

The positive electrode active material composite 100z is placed in a state where electrons can be donated to and accepted from the positive electrode current collector 1104. That is, the positive electrode active material composite 100z is electrically connected to the positive electrode current collector 1104. An undercoat layer may be provided in the positive electrode current collector 1104. In that case, the positive electrode active material composite 100z is electrically connected to the positive electrode current collector 1104 with the undercoat layer therebetween. The positive electrode active material composite 100z may be electrically connected to the positive electrode current collector 1104 with the conductive material therebetween.

### [Positive Electrode Active Material Composite]

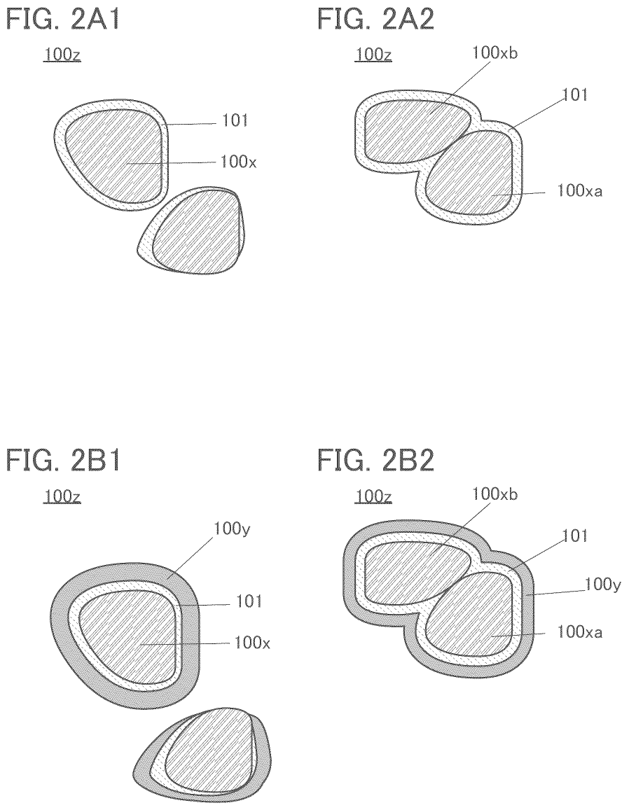

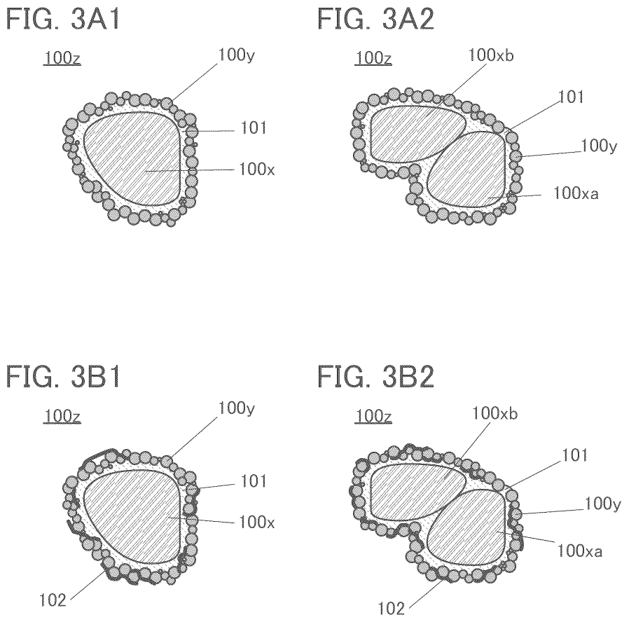

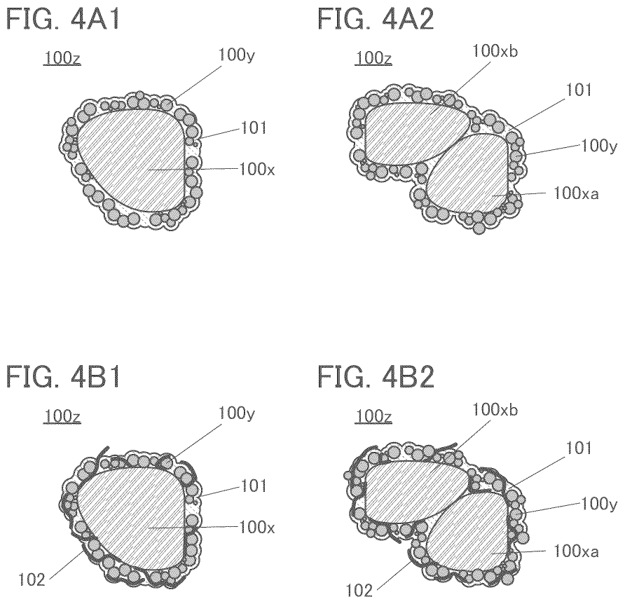

FIG. 2A1 to FIG. 2B2, FIG. 3A1 to FIG. 3B2, and FIG. 4A1 to FIG. 4B2 are schematic cross-sectional views each illustrating the positive electrode active material composite 100z.

FIG. 2A1 and FIG. 2A2 are diagrams each illustrating the positive electrode active material composite 100z including the first active material 100x functioning as a positive electrode active material and the coating material 101 covering at least part of the first active material 100x. Note that although one first active material 100x is covered with the coating material 101 in FIG. 2A1, the present invention is not limited thereto, and a plurality of the first active materials 100x may be covered with the coating material 101. For example, as illustrated in FIG. 2A2, at least parts of a first active material 100xa and a first active material 100xb may be covered with the coating material 101. FIG. 2A2 illustrates a case where at least parts of the first active material 100xa and the first active material 100xb are in contact with each other; however, the first active material 100xa and the first active material 100xb are not necessarily directly in contact with each other.

In the state where at least part of the particle surface, desirably, substantially the entire particle surface of the particulate first active material 100x functioning as a positive electrode active material is covered with the coating material 101, a region where the first active material 100x is directly in contact with an electrolyte 114 is reduced. This can inhibit release of a transition metal element and/or oxygen from the first active material 100x in a high-voltage charged state to inhibit a capacity reduction due to repeated charge and discharge. Since the first active material 100x is covered with the coating material 101 that is electrochemically stable even in a high-voltage charged state at high temperatures, a secondary battery using the positive electrode active material composite 100z of one embodiment of the present invention can have effects such as an improvement in stability at high temperatures and an improvement in fire resistance.

In particular, the use of a material having excellent stability in a high-voltage charged state as the first active material 100x, such as lithium cobalt oxide containing magnesium and fluorine, lithium cobalt oxide containing magnesium, fluorine, aluminum, and nickel, or lithium nickel-cobalt-manganese oxide with a molar ratio of nickel:cobalt:manganese=8:1:1, nickel:cobalt:manganese=9:0.5:0.5, or the like allows the positive electrode active material composite 100z to have further improved durability and further improved stability in a high-voltage charged state. In addition, the secondary battery using the positive electrode active material composite 100z can have further improved heat resistance and/or fire resistance.

Note that the lithium cobalt oxide containing magnesium, fluorine, aluminum, and nickel has features in which a large amount of magnesium, fluorine, or aluminum is contained in a surface portion of the positive electrode active material and nickel is widely distributed in the whole particle, and exhibits remarkably excellent charge and discharge cycle performance at high voltage, and thus is a material particularly preferred as the first active material 100x. In the case where the surface portion of the positive electrode active material contains a large amount of magnesium, fluorine, or aluminum, the count number of the characteristic X-rays derived from magnesium, fluorine, or aluminum has the maximum value in the surface portion in, for example, a STEM-EDX line analysis. Here, the surface portion refers to a region that is within approximately 10 nm from a surface toward an inner portion of a positive electrode active material, and does not include a conductive material. Note that a crack portion included in the positive electrode active material includes a surface portion, and a crack portion generated before the addition of magnesium, fluorine, or aluminum in the formation of the positive electrode active material includes a surface portion containing a large amount of magnesium, fluorine, or aluminum.

FIG. 2B1, FIG. 2B2, and FIG. 3A1 to FIG. 3B2 are diagrams each illustrating the positive electrode active material composite 100z including the first active material 100x functioning as a positive electrode active material and the second active material 100y in contact with the first active material 100x with the coating material 101 covering at least part of the first active material 100x therebetween. Note that although one first active material 100x is covered with the coating material 101 in FIG. 2B1, FIG. 3A1, and FIG. 3B1, the present invention is not limited thereto, and a plurality of the first active materials 100x may be covered with the coating material 101. For example, as illustrated in FIG. 2B2, FIG. 3A2, and FIG. 3B2, at least parts of the first active material 100xa and the first active material 100xb may be covered with the coating material 101. FIG. 2B2, FIG. 3A2, and FIG. 3B2 each illustrate a case where at least parts of the first active material 100xa and the first active material 100xb are in contact with each other; however, the first active material 100xa and the first active material 100xb are not necessarily directly in contact with each other.

Note that FIG. 2B1 and FIG. 2B2 each illustrate a case where a composing process of the second active material 100y using a liquid phase reaction such as a coprecipitation method, a hydrothermal method, or a sol-gel method is performed when the second active material 100y forms a layer.

FIG. 3A1 to FIG. 3B2 each illustrate a case where a plurality of the second active materials 100y are in contact with the first active material 100x with the coating material 101 covering at least part of the first active material 100x therebetween, for example, a case where a composing process of the second active material 100y using mechanical energy such as a mechanochemical method, a mechanofusion method, or a ball mill method is performed.

The positive electrode active material composite 100z is described in which the coating material 101 covers at least part of the particle surface, desirably, substantially the entire particle surface of the particulate first active material 100x functioning as a positive electrode active material, and the second active material 100y in contact with the first active material 100x with the coating material 101 therebetween is included. In the positive electrode active material composite 100z including the second active material 100y in contact with the first active material 100x with the coating material 101 therebetween, a region where the first active material 100x is directly in contact with the electrolyte 114 is reduced. This can inhibit release of a transition metal element and/or oxygen from the first active material 100x in a high-voltage charged state to inhibit a capacity reduction due to repeated charge and discharge. When the coating material 101 and the second active material 100y are materials that are electrochemically stable even in a high-voltage charged state at high temperatures, since the first active material 100x is covered with them, a secondary battery using the positive electrode active material composite 100z of one embodiment of the present invention can have effects such as an improvement in stability at high temperatures and an improvement in fire resistance.

In particular, the use of the material having excellent stability in a high-voltage charged state as the first active material 100x, such as lithium cobalt oxide containing magnesium and fluorine, lithium cobalt oxide containing magnesium, fluorine, aluminum, and nickel, or lithium nickel-cobalt-manganese oxide with a molar ratio of nickel:cobalt:manganese=8:1:1, nickel:cobalt:manganese=9:0.5:0.5, or the like allows the positive electrode active material composite 100z to have further improved durability and further improved stability in a high-voltage charged state. In addition, the secondary battery using the positive electrode active material composite 100z can have further improved heat resistance and/or fire resistance.

Note that the lithium cobalt oxide containing magnesium, fluorine, aluminum, and nickel has features in which a large amount of magnesium, fluorine, or aluminum is contained in a surface portion of the positive electrode active material and nickel is widely distributed in the whole particle, and exhibits remarkably excellent repeated charge and discharge performance at high voltage, and thus is a material particularly preferred as the first active material 100x. In the case where the surface portion of the positive electrode active material contains a large amount of magnesium, fluorine, or aluminum, the count number of the characteristic X-rays derived from magnesium, fluorine, or aluminum has the maximum value in the surface portion in, for example, a STEM-EDX line analysis. Here, the surface portion refers to a region within approximately 10 nm from a surface of a positive electrode active material. Note that a crack portion included in the positive electrode active material includes a surface portion, and a crack portion generated before the addition of magnesium, fluorine, or aluminum in the formation of the positive electrode active material includes a surface portion containing a large amount of magnesium, fluorine, or aluminum.

In the positive electrode active material composite 100z of one embodiment of the present invention as described above, the first active material 100x is not in contact with the electrolyte 114 and thus is inhibited from being deteriorated by the electrolyte. The deterioration results from defects generated in the first active material 100x in some cases, and examples of the defects include a pit. A pit refers to a region from which some layers of main components, for example, cobalt and oxygen, of the first active material 100x are extracted in a charge and discharge cycle test. For example, it is considered that cobalt is sometimes eluted into an electrolyte. A pit sometimes develops in the inner side direction of the active material in a charge and discharge cycle test. Note that an opening shape of a pit is not circular but a wide groove-like shape. With a structure in which the electrolyte 114 and the first active material 100x are not in contact with each other, generation and development of the defects, particularly a pit, can be inhibited.

The coating material 101 is preferably a material having higher conductivity than the first active material 100x in which case charge and discharge characteristics, particularly charge capacity and discharge capacity at a high rate, are improved. When a positive electrode active material and a conductive material are subjected to a composing process to be the positive electrode active material composite 100z including the coating material 101, a conductive path can be formed effectively with a conductive material in a small quantity, and the electrode density of a positive electrode can be improved, which is preferable.

When the positive electrode active material composite 100z includes the second active material 100y in contact with the first active material 100x with the coating material 101 therebetween, the positive electrode active material composite 100z can be regarded as having a two-layer structure in the surface portion. Note that the positive electrode active material composite 100z of one embodiment of the present invention is not limited to the case of having a two-layer structure of the coating material 101 and the second active material 100y. As another example of the positive electrode active material composite 100z of one embodiment of the present invention, a structure may be employed in which a glass active material mixed layer including the coating material 101 and the second active material 100y cover at least part of the surface of the first active material 100x as illustrated in FIG. 4A1 to FIG. 4B2.

The positive electrode active material composite 100z of one embodiment of the present invention may contain the graphene compound 102 in the surface portion of the positive electrode active material composite 100z or a mixed layer of the coating material 101 and the active material as illustrated in FIG. 3B1, FIG. 3B2, FIG. 4B1, and FIG. 4B2. Here, carbon fiber such as carbon black or carbon nanotube may be used instead of the graphene compound 102.

Glass can be used for the coating material 101. Glass is also referred to as a material including an amorphous part. Examples of the material including an amorphous part include a material containing one or more selected from SiO₂, SiO, Al₂O₃, TiO₂, Li₄SiO₄, Li₃PO₄, Li₂S, SiS₂, B₂S₃, GeS₄, AgI, Ag₂O, Li₂O, P₂O₅, B₂O₃, V₂O₅, and the like; Li₇P₃S₁₁; and Li_{i+x+y}AlₓTi₂₋ₓSi_{y}P_{3-y}O₁₂ (0<x<2 and 0<y<3). The material including an amorphous part can be used in the state where the entire part is amorphous or in the state of crystallized glass part of which is crystallized (also referred to as glass ceramic). The coating material 101 desirably has lithium-ion conductivity. Having the lithium-ion conductivity can also be regarded as having a diffusion property of lithium ions and a penetration property of lithium ions. The melting point of the coating material 101 is preferably 800° C. or lower, further preferably 500° C. or lower. The coating material 101 preferably has electron conductivity. Furthermore, the coating material 101 preferably has a softening point of 800° C. or lower, and Li₂O—B₂O₃—SiO₂ based glass can be used, for example.

A material containing carbon can be used as the coating material 101. A material that can be used as a conductive material, for example, carbon black such as acetylene black or furnace black, graphite such as artificial graphite or natural graphite, carbon fiber such as carbon nanofiber or carbon nanotube, or a graphene compound, can be used as the material containing carbon.

The material including an amorphous part and the material containing carbon may be mixed.

As the second active material 100y, one or more of an oxide and LiM2PO₄ (M2 is one or more selected from Fe, Ni, Co, and Mn) can be used. Examples of the oxide include aluminum oxide, zirconium oxide, hafnium oxide, and niobium oxide. Examples of LiM2PO₄ (M2 is one or more selected from, Fe, Ni, Co, and Mn) include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1).

The positive electrode active material composite 100z is preferably covered with a molecular crystalline electrolyte. The molecular crystalline electrolyte can function as a binder of the positive electrode active material layer 1105. The molecular crystalline electrolyte is preferably a material having high ionic conductivity, and the positive electrode active material composite 100z covered with the molecular crystalline electrolyte can donate and accept carrier ions to and from the electrolyte 114.

### [Positive Electrode Active Material]

As the first active material 100x, a composite oxide represented by LiM1O₂ (M1 is one or more selected from Fe, Ni, Co, and Mn) and having a layered rock-salt crystal structure can be used. Alternatively, as the first active material 100x, a composite oxide that is represented by LiM1O₂ and to which an additive element X is added can be used. As the additive element X included in the first active material 100x, one or more selected from nickel, cobalt, magnesium, calcium, chlorine, fluorine, aluminum, manganese, titanium, zirconium, yttrium, vanadium, gallium, iron, chromium, niobium, lanthanum, hafnium, zinc, silicon, sulfur, phosphorus, boron, and arsenic are preferably used. These elements further stabilize the crystal structure included in the first active material 100x in some cases. That is, the first active material 100x can contain lithium cobalt oxide containing magnesium and fluorine; lithium cobalt oxide containing magnesium, fluorine, aluminum, and nickel; lithium cobalt oxide containing magnesium, fluorine, and titanium; lithium nickel-cobalt oxide containing magnesium and fluorine; lithium cobalt-aluminum oxide containing magnesium and fluorine; lithium nickel-cobalt-aluminum oxide; lithium nickel-cobalt-aluminum oxide containing magnesium and fluorine; lithium nickel-cobalt-manganese oxide containing magnesium and fluorine; or the like. Here, as for the proportions of the transition metals of the lithium nickel-cobalt-manganese oxide, the proportion of nickel is preferably high; e.g., a material with a molar ratio of nickel:cobalt:manganese=8:1:1 or nickel:cobalt:manganese=9:0.5:0.5 is preferred. Lithium nickel-cobalt-manganese oxide containing calcium is preferably included as the above-described lithium nickel-cobalt-manganese oxide.

Alternatively, as the first active material 100x, a material in which secondary particles of the composite oxide represented by LiM1O₂ (M1 is one or more selected from Fe, Ni, Co, and Mn) are coated with a metal oxide may be used. As the metal oxide, an oxide of one or more metals selected from Al, Ti, Nb, Zr, La, and Li can be used. For example, a metal-oxide-coated composite oxide in which secondary particles of the composite oxide represented by LiM1O₂ (M1 is one or more selected from Fe, Ni, Co, and Mn) are coated with aluminum oxide can be used as the first active material 100x. For example, a metal-oxide-coated composite oxide in which secondary particles of lithium nickel-cobalt-manganese oxide with a molar ratio of nickel:cobalt:manganese=8:1:1 or nickel:cobalt:manganese=9:0.5:0.5 are coated with aluminum oxide can be used. Here, the thickness of the coating layer is preferably small, for example, greater than or equal to 1 nm and less than or equal to 200 nm, further preferably greater than or equal to 1 nm and less than or equal to 100 nm. Lithium nickel-cobalt-manganese oxide containing calcium is preferably included as the above-described lithium nickel-cobalt-manganese oxide.

As the first active material 100x, any of active materials in the following embodiments can be used.

As the second active material 100y, one or more of an oxide and LiM2PO₄ having an olivine crystal structure (M2 is one or more selected from Fe, Ni, Co, and Mn) can be used. Examples of the oxide include aluminum oxide, zirconium oxide, hafnium oxide, and niobium oxide. Examples of LiM2PO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1). In addition, a carbon coating layer may be provided on the particle surface of the second active material 100y.

### [Conductive Material]

For example, one kind or two or more kinds of carbon black such as acetylene black or furnace black, graphite such as artificial graphite or natural graphite, carbon fiber such as carbon nanofiber or carbon nanotube, and a graphene compound can be used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound preferably has a bent shape. A graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. A graphene compound may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced oxide graphene oxide is preferably 1 or more. The reduced graphene oxide with such an intensity ratio can function as a conductive material with high conductivity even with a small amount.

A graphene compound has excellent electrical characteristics of high conductivity and excellent physical properties of high flexibility and high mechanical strength in some cases. A graphene compound has a sheet-like shape. A graphene compound has a curved surface in some cases, thereby enabling low-resistant surface contact. Furthermore, a graphene compound has extremely high conductivity even with a small thickness in some cases and thus allows a conductive path to be formed in an active material layer efficiently even with a small amount. Hence, a graphene compound is preferably used as the conductive material, in which case the area where the active material and the conductive material are in contact with each other can be increased. The graphene compound preferably covers 80% or more of the area of the active material. Note that a graphene compound preferably clings to at least a portion of an active material particle. The graphene compound preferably overlays at least a portion of the active material particles. The shape of the graphene compound preferably conforms to at least a portion of the shape of the active material particles. The shape of active material particles means, for example, an uneven surface of a single active material particle or an uneven surface formed by a plurality of active material particles. A graphene compound preferably surrounds at least a portion of an active material particle. A graphene compound may have a hole.

### [Binder]

As the binder, for example, one kind or two or more kinds of materials such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose can be used. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as a dispersion medium. A combination of polyvinylidene fluoride (PVDF) and N-methylpyrrolidone (NMP) is preferably used as the suitable combination of the binder and the dispersion medium.

### [Current Collector]

The current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. It is also possible to use an aluminum alloy to which an element that improves heat resistance, such as silicon, titanium, neodymium, scandium, or molybdenum, is added. The current collector can have a foil-like shape, a plate-like shape, a sheet-like shape, a net-like shape, a punching-metal shape, an expanded-metal shape, or the like as appropriate. The current collector preferably has a thickness greater than or equal to 5 m and less than or equal to 30 m.

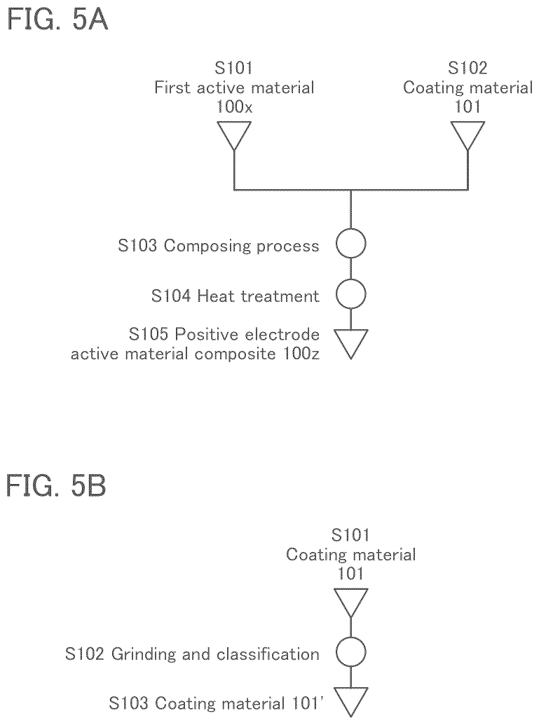

Examples of a method for forming a positive electrode active material composite of one embodiment of the present invention are described with reference to FIG. 5 to FIG. 7.

As a method for forming a positive electrode active material composite, a formation method using a composing process with the use of the first active material 100x, the second active material 100y, and the coating material 101 using mechanical energy is described. Note that the present invention should not be interpreted as being limited to these descriptions.

In a method 1 for forming a positive electrode active material composite, a case where the first active material 100x and the coating material 101 compose a composite is described; in a method 2 for forming a positive electrode active material composite, a case where the first active material 100x and the coating material 101 compose a composite, and then the composite and the second active material 100y compose a composite is described; and in a method 3 for forming a positive electrode active material composite, a case where the first active material 100x, the second active material 100y, and the coating material 101 compose a composite at the same time is described.

### [Method 1 for Forming Positive Electrode Active Material Composite]

The first active material 100x is prepared in Step S101 in FIG. 5A, and the coating material 101 is prepared in Step S102.

As the first active material 100x, it is possible to use a composite oxide represented by LiM1O₂ (M1 is one or more selected from Fe, Ni, Co, and Mn) to which the additive element X is added, which is formed by a formation method described in the following embodiments, e.g., lithium cobalt oxide containing magnesium and fluorine, or lithium cobalt oxide containing magnesium, fluorine, aluminum, and nickel. In particular, lithium cobalt oxide containing magnesium, fluorine, aluminum, and nickel is preferably subjected to initial heating described in the following embodiments. As another example of the first active material 100x, lithium nickel-cobalt-manganese oxide can be used. Here, as for the proportions of the transition metals of the lithium nickel-cobalt-manganese oxide, the proportion of nickel is preferably high; e.g., a material with a molar ratio of nickel:cobalt:manganese=8:1:1 or nickel:cobalt:manganese=9:0.5:0.5 is preferred. Moreover, a metal-oxide-coated composite oxide in which secondary particles of lithium nickel-cobalt-manganese oxide are coated with aluminum oxide can be used. Here, the thickness of the coating layer is preferably small, for example, greater than or equal to 1 nm and less than or equal to 200 nm, further preferably greater than or equal to 1 nm and less than or equal to 100 nm.

A material including an amorphous part can be used as the coating material 101. Examples of the material including an amorphous part include a material containing one or more selected from SiO₂, SiO, Al₂O₃, TiO₂, Li₄SiO₄, Li₃PO₄, Li₂S, SiS₂, B₂S₃, GeS₄, AgI, Ag₂O, Li₂O, P₂O₅, B₂O₃, V₂O₅, and the like; Li₇P₃S₁₁; and Li_{1+x+y}AlₓTi₂₋ₓSi_{y}P_{3-y}O₁₂ (0<x<2 and 0<y<3). The material including an amorphous part can be used in the state where the entire part is amorphous or in the state of crystallized glass part of which is crystallized (also referred to as glass ceramic). The coating material 101 desirably has lithium-ion conductivity. Having the lithium-ion conductivity can also be regarded as having a diffusion property of lithium ions and a penetration property of lithium ions. The melting point of the coating material 101 is preferably 800° C. or lower, further preferably 500° C. or lower. The coating material 101 preferably has electron conductivity. Furthermore, the coating material 101 preferably has a softening point of 800° C. or lower, and Li₂O—B₂O₃—SiO₂ based glass can be used, for example.

Next, in Step S103, a composing process of the first active material 100x and the coating material 101 is performed. In the case of using mechanical energy, the composing process can be performed by a mechanochemical method. Alternatively, the process may be performed by a mechanofusion method.

In the case where a ball mill is used in Step S103, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composing process in Step S103 can create a state where at least part of the particle surface, desirably, substantially the entire particle surface of the particulate first active material 100x is covered with the coating material 101.

Next, heat treatment is performed in Step S104. The heat treatment in Step S104 is desirably performed at a temperature higher than or equal to the melting point of the coating material 101. For example, the heat treatment is performed in an oxygen-containing atmosphere at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours. A step of crushing the fixed positive electrode active material composite 100z may be included after Step S104.

Through the above steps, the positive electrode active material composite 100z of one embodiment of the present invention shown in FIG. 5A can be formed (Step S105).

Note that in order to obtain a favorable coating state in the composing process, the ratio of the particle diameter of the coating material 101 to the particle diameter of the first active material 100x (the particle diameter of the coating material 101/the particle diameter of the first active material 100x) is preferably greater than or equal to 1/100 and less than or equal to 1/50, further preferably greater than or equal to 1/200 and less than or equal to 1/100. To adjust the particle diameter of the coating material 101, a microparticulation process (Step S102) is performed by the method shown in FIG. 5B, so that a microparticulated coating material 101′ (Step S103) can be obtained.

Note that the coating material 101 desirably has electron conductivity, but when the coating material 101 has low electron conductivity, mixing a carbon fiber conductive material such as a graphene compound, carbon black, or carbon nanotube with the coating material 101 in Step S103 in FIG. 5A can impart electron conductivity to the positive electrode active material composite 100z.

### [Method 2 for Forming Positive Electrode Active Material Composite]

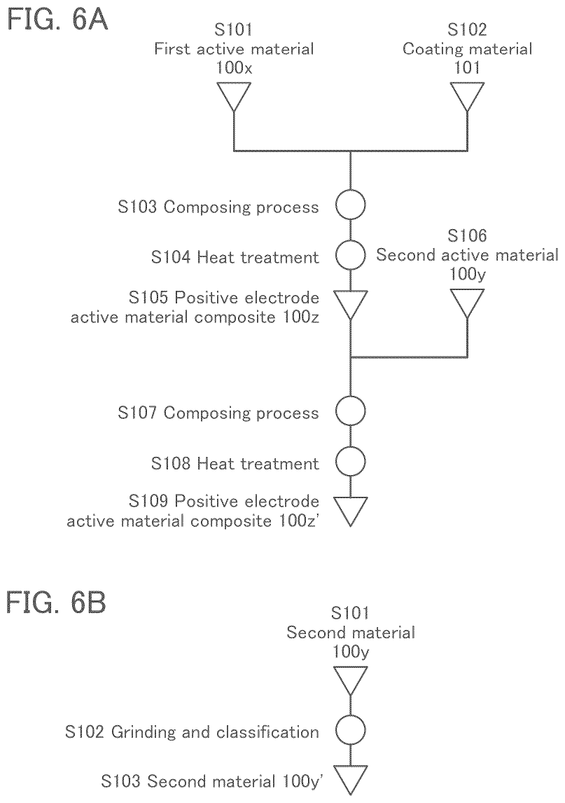

The first active material 100x is prepared in Step S101 in FIG. 6A, and the coating material 101 is prepared in Step S102.

Next, in Step S103, a composing process of the first active material 100x and the coating material 101 is performed. In the case of using mechanical energy, the composing process can be performed by a mechanochemical method. Alternatively, the process may be performed by a mechanofusion method.

In the case where a ball mill is used in Step S103, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composing process in Step S103 can create a state where at least part of the particle surface, desirably, substantially the entire particle surface of the particulate first active material 100x is covered with the coating material 101.

Next, heat treatment is performed in Step S104 to obtain the positive electrode active material composite 100z in Step S105. The heat treatment in Step S104 is preferably performed at a temperature higher than or equal to the melting point of the coating material 101. For example, the heat treatment is performed in an oxygen-containing atmosphere at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours. A step of crushing the fixed positive electrode active material composite 100z may be included after Step S104.

Next, in Step S106, the second active material 100y is prepared.

As the second active material 100y, LiM2PO₄ (M2 is one or more selected from Fe, Ni, Co, and Mn) can be used. Alternatively, an oxide can be used as the second active material 100y. Examples of the oxide include aluminum oxide, zirconium oxide, hafnium oxide, and niobium oxide. The above-described material, e.g., LiFePO₄, LiMnPO₄, LiFeₐMn_{b}PO₄ (a+b is 1 or less, 0<a<1, 0<b<1), or LiFeₐNi_{b}PO₄ (a+b is 1 or less, 0<a<1, 0<b<1) can be used as LiM2PO₄. In addition, a carbon coating layer may be provided on the particle surface of the second active material 100y.

Note that in the case where a material functioning as a positive electrode active material is used as the second active material 100y, it is possible to select, as a combination of the first active material 100x and the second active material 100y, a combination that is less likely to generate a step in a charge-discharge curve in accordance with characteristics required for a secondary battery or a combination that generates a step in a charge-discharge curve in a desired charge rate.

Next, in Step S107 in FIG. 6A, a composing process of the positive electrode active material composite 100z in Step S105 and the second active material 100y is performed. In the case of using mechanical energy, the composing process can be performed by a mechanochemical method. Alternatively, the process may be performed by a mechanofusion method.

In the case where a ball mill is used in Step S107, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composing process in Step S107 can create a state where at least part of the surface, desirably, substantially the entire surface of the positive electrode active material composite 100z is covered with the second active material 100y.

Next, heat treatment is performed in Step S108. The heat treatment in Step S108 is preferably performed in an atmosphere containing oxygen or nitrogen at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours. A step of crushing the fixed positive electrode active material composite 100z′ may be included after Step S108.

Through the above steps, the positive electrode active material composite 100z′ of one embodiment of the present invention shown in FIG. 6A can be formed (Step S109).

Note that in order to obtain a favorable coating state in the composing process, the ratio of the particle diameter of the coating material 101 to the particle diameter of the first active material 100x (the particle diameter of the coating material 101/the particle diameter of the first active material 100x) is preferably greater than or equal to 1/100 and less than or equal to 1/50, further preferably greater than or equal to 1/200 and less than or equal to 1/100. To adjust the particle diameter of the coating material 101, a microparticulation process may be performed by the method shown in FIG. 5B.

Note that the coating material 101 desirably has electron conductivity, but when the coating material 101 has low electron conductivity, mixing a carbon fiber conductive material such as a graphene compound, carbon black, or carbon nanotube with the coating material 101 in Step S103 in FIG. 6A can impart electron conductivity.

Note that in order to obtain a favorable coating state in the composing process, the ratio of the particle diameter of the second active material 100y to the particle diameter of the first active material 100x (the particle diameter of the second active material 100y/the particle diameter of the first active material 100x) is preferably greater than or equal to 1/100 and less than or equal to 1/50, further preferably greater than or equal to 1/200 and less than or equal to 1/100. To adjust the particle diameter of the second active material 100y, a microparticulation process (Step S102) is performed by the method shown in FIG. 6B, so that a microparticulated second active material 100y′ (Step S103) can be obtained.

### [Method 3 for Forming Positive Electrode Active Material Composite]

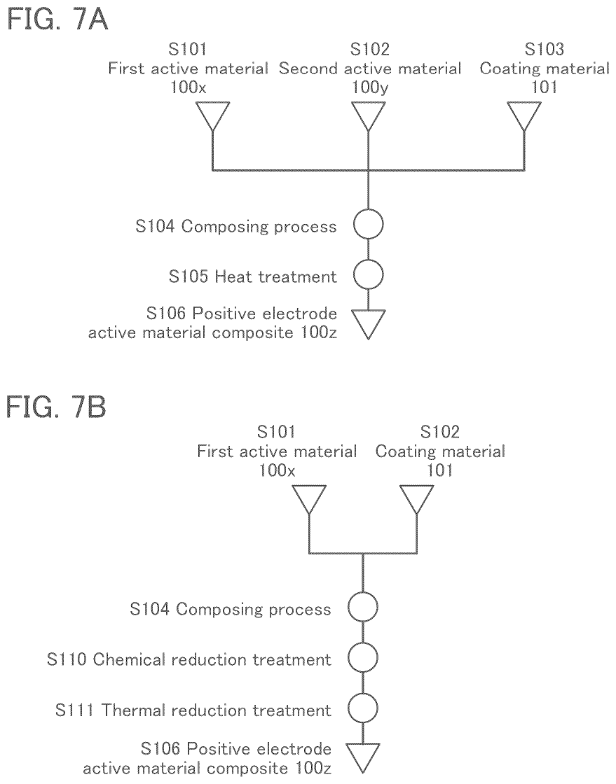

In FIG. 7A, the first active material 100x is prepared in Step S101, the second active material 100y is prepared in Step S102, and the coating material 101 is prepared in Step S103.

Next, in Step S104, a composing process of the first active material 100x, the second active material 100y, and the coating material 101 is performed. In the case of using mechanical energy, the composing process can be performed by a mechanochemical method. Alternatively, the process may be performed by a mechanofusion method.

In the case where a ball mill is used in Step S104, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composing process in Step S104 can create a state where at least part of the particle surface, desirably, substantially the entire particle surface of the particulate first active material 100x is covered with a mixture of the second active material and the coating material 101.

Next, heat treatment is performed in Step S105. The heat treatment in Step S105 is desirably performed at a temperature higher than or equal to the melting point of the coating material 101. For example, the heat treatment is performed in an atmosphere containing oxygen or nitrogen at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours. A step of crushing the fixed positive electrode active material composite 100z may be included after Step S104.

Through the above steps, the positive electrode active material composite 100z of one embodiment of the present invention shown in FIG. 7A can be formed (Step S106).

Note that in order to obtain a favorable coating state in the composing process, the ratio of the particle diameter of the coating material 101 to the particle diameter of the first active material 100x (the particle diameter of the coating material 101/the particle diameter of the first active material 100x) is preferably greater than or equal to 1/100 and less than or equal to 1/50, further preferably greater than or equal to 1/200 and less than or equal to 1/100. To adjust the particle diameter of the coating material 101, a microparticulation process may be performed by the method shown in FIG. 5B.

Note that the coating material 101 desirably has electron conductivity, but when the coating material 101 has low electron conductivity, mixing a carbon fiber conductive material such as a graphene compound, carbon black, or carbon nanotube with the coating material 101 in Step S104 in FIG. 7A can impart electron conductivity.

### [Method 4 for Forming Positive Electrode Active Material Composite]

Although FIG. 5A to FIG. 7A show examples in which a composing process is performed using mechanical energy, one embodiment of the present invention is not limited thereto. A method for wet mixing the first active material 100x and the coating material 101 is described with reference to FIG. 7B.

The first active material 100x is prepared in Step S101 in FIG. 7B, and the coating material 101 is prepared in Step S102.

An example of the coating material 101 suitable for wet mixing is graphene oxide. Graphene oxide easily dispersed in a polarity solvent such as water or NMP, whereby the coating material 101 is easily attached to the surface of the first active material 100x with a small amount.

For example, the composing process by wet mixing can be performed in the following manner. First, the coating material 101 and a solvent are mixed. The first active material 100x is added to the mixture and mixing is performed. A binder is further added to the mixture and mixing is performed to form a slurry. Mixing can be performed with the use of a planetary centrifugal mixer, for example. A solvent is preferably added as appropriate to adjust viscosity. The slurry is applied to the current collector and dried to form an electrode layer. The slurry can be applied to a current collector by, for example, a doctor blade method. In this specification and the like, application refers to a step of forming a slurry to a predetermined thickness and may be rephrased as forming, spreading, or the like. Through such steps, the coating material 101 can be attached to the surface of the first active material 100x (Step S104).

In the case where graphene oxide is used as the coating material 101, reduction treatment is performed on the electrode layer formed as above. As the reduction treatment, chemical reduction and/or thermal reduction can be performed. In particular, thermal reduction is preferably performed after chemical reduction, in which case the graphene oxide can be sufficiently reduced even when the temperature of the thermal reduction is decreased, so that deterioration of the binder can be avoided.

In FIG. 7B, first, chemical reduction is performed in Step S110. For example, chemical reduction is performed by immersing the electrode layer formed as above in an aqueous solution of a reducing agent. Examples of the reducing agent include an organic acid typified by ascorbic acid, hydrogen, sulfur dioxide, sulfurous acid, sodium sulfite, sodium hydrogen sulfite, ammonium sulfite, and phosphorous acid.

In the case where ascorbic acid is used as the reducing agent, first, ascorbic acid is dissolved in a solvent to form a reducing agent solution (ascorbic acid solution). As the solvent, water, a mixture of water and NMP, ethanol, a mixture of water and ethanol, or the like can be used. Then, the electrode layer formed as above is immersed in the solution. This treatment can be performed for longer than or equal to 30 minutes and shorter than or equal to 10 hours, for example, and is preferably performed for approximately 1 hour. Moreover, heating is preferably performed, in which case the chemical reduction time can be shortened. For example, heating to a temperature higher than or equal to room temperature and lower than or equal to 100° C., preferably approximately 60° C. can be performed.

Next, thermal reduction is performed in Step S111. Thermal reduction refers to treatment for heating the electrode layer formed as above. The heating is preferably performed under a reduced pressure. A glass tube oven can be used for the heating, for example. A glass tube oven can perform heating under a reduced pressure of approximately 1 kPa.

The optimal heating temperature and heating time are different depending on the conductive material and the material of the binder. For example, in the case where graphene oxide is used as the conductive material and PVDF is used for the binder, the heating temperature is preferably a temperature at which the graphene oxide is sufficiently reduced and PVDF is not adversely affected. Specifically, the temperature is preferably higher than or equal to 125° C. and lower than or equal to 200° C. At a temperature lower than or equal to 100° C., there is a concern that reduction of graphene oxide does not sufficiently proceed. Meanwhile, at a temperature higher than or equal to 250° C., there is concern that the PVDF is adversely affected and the slurry is likely to be separated from the current collector. The heating time is preferably longer than or equal to 1 hour and shorter than or equal to 20 hours. In the case where the heating time is shorter than 1 hour, there is a concern that graphene oxide is not sufficiently reduced. Meanwhile, in the case where the heating time is longer than 20 hours, productivity is decreased.

A functional group that is likely to be reduced is different between chemical reduction and thermal reduction. Chemical reduction has a great effect of reducing a carbonyl group (C═O) and a carboxy group (—COOH) in graphene oxide by protonation. In contrast, thermal reduction is effective in reducing a hydroxy group (—OH) in graphene oxide by dehydration. Therefore, performing both chemical reduction and thermal reduction can achieve efficient reduction and improve conductivity of reduced graphene oxide.

Note that in the wet mixing and the chemical reduction, the crystal structure of the positive electrode active material is likely to be broken by the influence of exposure to water or the like. Thus, in the case of employing this formation method, a positive electrode active material having a highly stable crystal structure is preferably used. For example, lithium cobalt oxide containing magnesium, fluorine, nickel, and aluminum, which is described in the following embodiments, is preferable because of having a highly stable crystal structure. A positive electrode active material having an olivine crystal structure such as lithium phosphate is also preferable because of its high stability.

Through the above steps, the positive electrode active material composite 100z of one embodiment of the present invention shown in FIG. 7B can be formed (Step S106).

The contents in this embodiment can be freely combined with the contents in the other embodiments.

### Embodiment 2

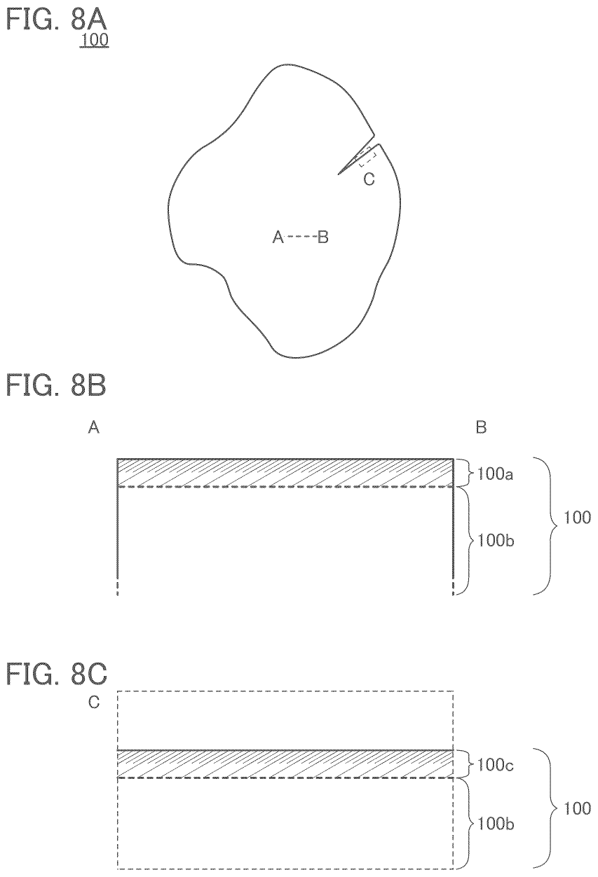

In this embodiment, a positive electrode active material of one embodiment of the present invention is described with reference to FIG. 8 to FIG. 14.

### [Structure of Positive Electrode Active Material]

FIG. 8A is a schematic top view of a positive electrode active material 100 which is one embodiment of the present invention. FIG. 8B is a schematic cross-sectional view taken along A-B in FIG. 8A.

### <Included Elements and Distribution>

The positive electrode active material 100 contains lithium, a transition metal, oxygen, and an additive element X. The positive electrode active material 100 can be regarded as a composite oxide represented by LiM1O₂ (M1 is one or more selected from Fe, Ni, Co, and Mn) to which the additive element X is added.

As the transition metal contained in the positive electrode active material 100, a metal that can form, together with lithium, a composite oxide having the layered rock-salt structure belonging to the space group R-3m is preferably used. For example, at least one of manganese, cobalt, and nickel can be used. That is, as the transition metal contained in the positive electrode active material 100, only cobalt may be used, only nickel may be used, two metals of cobalt and manganese may be used or two metals of cobalt and nickel may be used, or three metals of cobalt, manganese, and nickel may be used. In other words, the positive electrode active material 100 can include a composite oxide containing lithium and the transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal in addition to cobalt, in which case a crystal structure may be more stable in a high-voltage charged state.

As the additive element X included in the positive electrode active material 100, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. These elements further stabilize the crystal structure of the positive electrode active material 100 in some cases. The positive electrode active material 100 can contain lithium cobalt oxide containing magnesium and fluorine; lithium cobalt oxide containing magnesium, fluorine, and titanium; lithium nickel-cobalt oxide containing magnesium and fluorine; lithium cobalt-aluminum oxide containing magnesium and fluorine; lithium nickel-cobalt-aluminum oxide; lithium nickel-cobalt-aluminum oxide containing magnesium and fluorine; lithium nickel-manganese-cobalt oxide containing magnesium and fluorine; or the like. In this specification and the like, the additive element X may be rephrased as a constituent of a mixture or a raw material or the like.

As illustrated in FIG. 8B, the positive electrode active material 100 includes a surface portion 100a and an inner portion 100b. The surface portion 100a preferably has a higher concentration of the additive element X than the inner portion 100b. The concentration of the additive element X preferably has a gradient as illustrated in FIG. 8B by gradation, in which the concentration increases from the inner portion toward the surface. In this specification and the like, the surface portion 100a refers to a region within approximately 10 nm from a surface of the positive electrode active material 100. A plane generated by a split and/or a crack may also be referred to as a surface, and a region within approximately 10 nm from the surface is referred to as a surface portion 100c as illustrated in FIG. 8C. A region which is deeper than the surface portion 100a and the surface portion 100c of the positive electrode active material 100 is referred to as the inner portion 100b. When the positive electrode active material 100 forms the positive electrode active material composite 100z, a plane generated by a crack is desirably covered with the coating material 101 as well.

In order to prevent the breakage of a layered structure formed of octahedrons of cobalt and oxygen even when lithium is extracted from the positive electrode active material 100 of one embodiment of the present invention by charge, the surface portion 100a having a high concentration of the additive element X, i.e., the outer portion of a particle, is reinforced.

The concentration gradient of the additive element X preferably exists uniformly in the entire surface portion 100a of the positive electrode active material 100. A situation where only part of the surface portion 100a has reinforcement is not preferable because stress might be concentrated on parts that do not have reinforcement. The concentration of stress on part of a particle might cause defects such as cracks from that part, leading to breakage of the positive electrode active material and a decrease in charge and discharge capacity.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charge and discharge, and is thus preferable. However, excess magnesium might adversely affect insertion and extraction of lithium.

Aluminum is trivalent and can exist at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum included as the additive element X enables the positive electrode active material 100 to have the crystal structure that is unlikely to be broken by repetitive charge and discharge.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. Note that in this specification and the like, an electrolyte solution corresponds to a liquid electrolyte.

The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can inhibit a capacity decrease due to repetitive charge and discharge.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive element X can be evaluated using energy dispersive X-ray spectroscopy (EDX). In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in a positive electrode active material particle is referred to as linear analysis in some cases.

By EDX surface analysis (e.g., element mapping), the concentrations of the additive element X in the surface portion 100a, the inner portion 100b, the vicinity of the crystal grain boundary, and the like of the positive electrode active material 100 can be quantitatively analyzed. By EDX linear analysis, the concentration distribution of the additive element X can be analyzed.

When the positive electrode active material 100 is analyzed with the EDX linear analysis, a peak of the magnesium concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

In addition, the distribution of fluorine contained in the positive electrode active material 100 preferably overlaps with the distribution of magnesium. Thus, when the EDX linear analysis is performed, a peak of the fluorine concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

Note that the concentration distribution may differ between the additive elements X. For example, in the case where the positive electrode active material 100 contains aluminum as the additive element X, the distribution of aluminum is preferably slightly different from that of magnesium and that of fluorine. For example, in the EDX linear analysis, the peak of the magnesium concentration (the position where the concentration has the maximum value) is preferably closer to the surface than the peak of the aluminum concentration (the position where the concentration has the maximum value) is in the surface portion 100a. For example, the peak of the aluminum concentration preferably exists in a region from the surface of the positive electrode active material 100 to a depth of 0.5 nm or more and 20 nm or less toward the center, and further preferably to a depth of 1 nm or more and 5 nm or less.

When the linear analysis or the surface analysis is performed on the positive electrode active material 100, the ratio (X/M1) between an additive element X and the transition metal M1 in the vicinity of the grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20. For example, when the additive element X is magnesium and the transition metal M1 is cobalt, the atomic ratio (Mg/Co) between magnesium and cobalt is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

As described above, an excess amount of the additive element in the positive electrode active material 100 might adversely affect insertion and extraction of lithium. The use of such a positive electrode active material 100 for a secondary battery might cause a resistance increase, a capacity decrease, and the like. Meanwhile, when the amount of additive is insufficient, the additive element is not distributed over the whole surface portion 100a, which might reduce the effect of maintaining the crystal structure. In this manner, the additive element X is adjusted so as to obtain an appropriate concentration in the positive electrode active material 100.

For this reason, the positive electrode active material 100 may include a region where excess additive element X is unevenly distributed, for example. With such a region, the excess additive element X is removed from the other region, and the additive element X concentration in most of the inner portion and the surface portion of the positive electrode active material 100 can be appropriate. An appropriate additive element X concentration in most of the inner portion and the surface portion of the positive electrode active material 100 can inhibit a resistance increase, a capacity decrease, and the like when the positive electrode active material 100 is used for a secondary battery. A feature of inhibiting a resistance increase of a secondary battery is extremely preferable especially in charge and discharge at a high rate.

In the positive electrode active material 100 including the region where the excess additive element X is unevenly distributed, mixing of the excess additive element X to some extent in the formation process is acceptable. This is preferable because the margin of production can be increased.

Note that in this specification and the like, uneven distribution means that the concentration of an element differs between a region A and a region B. It may be rephrased as segregation, precipitation, unevenness, deviation, high concentration, low concentration, or the like.

### <Crystal Structure>

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiM1O₂ (M1 is one or more selected from Fe, Ni, Co, and Mn) is given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

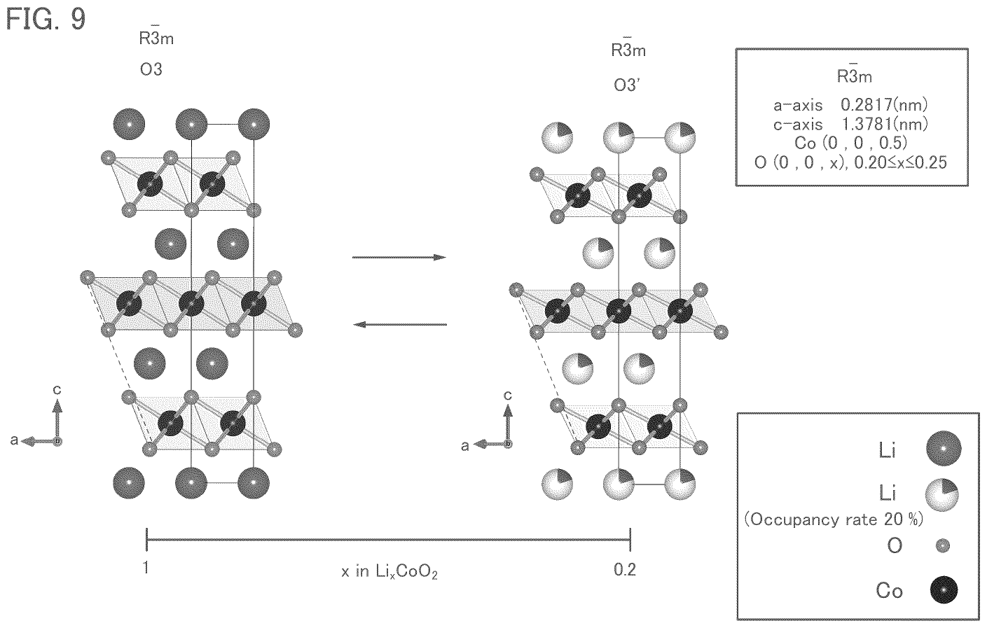

The structures of positive electrode active materials are described with reference to FIG. 9 to FIG. 14. In FIG. 9 to FIG. 14, the case where cobalt is used as the transition metal contained in the positive electrode active material is described.

### <Conventional Positive Electrode Active Material>

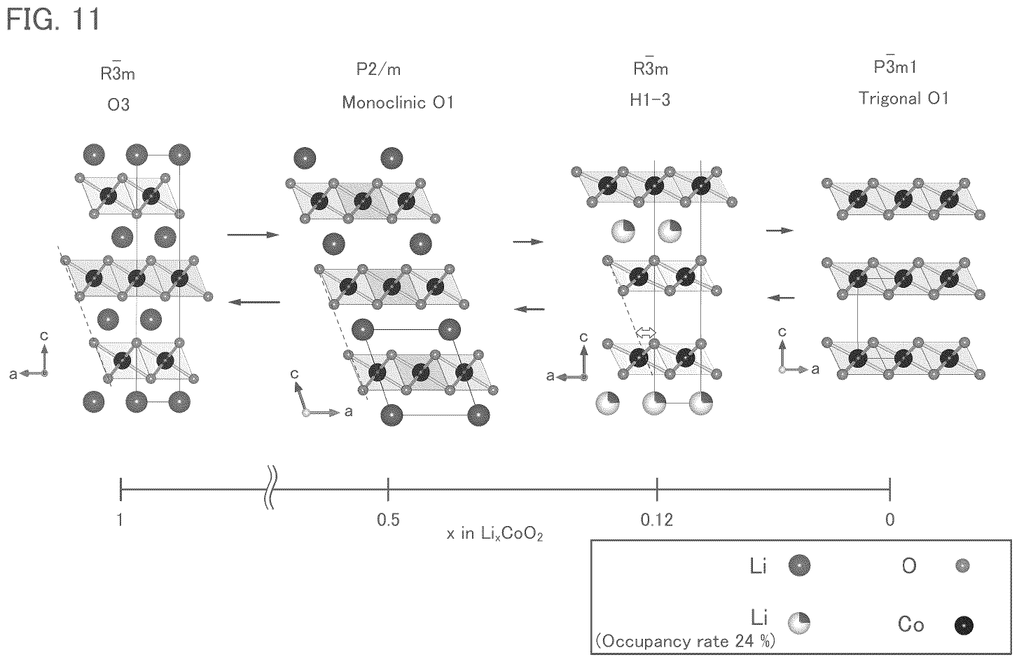

A positive electrode active material illustrated in FIG. 11 is lithium cobalt oxide (LiCoO₂ or LCO) to which halogen and magnesium are not added. The crystal structure of the lithium cobalt oxide illustrated in FIG. 11 changes depending on the charge depth. In other words, the crystal structure changes depending on the occupancy rate x of lithium in the lithium sites when the lithium cobalt oxide is referred to as LiₓCoO₂.

As illustrated in FIG. 11, lithium cobalt oxide in a state with x of 1 (discharged state) includes a region having the crystal structure belonging to the space group R-3m, and includes three CoO₂ layers in a unit cell. Thus, this crystal structure is referred to as an O3 type crystal structure in some cases. Note that the CoO₂ layer has a structure in which an octahedral structure with cobalt coordinated to six oxygen atoms continues in a plane direction in an edge-shared state.

Lithium cobalt oxide with x of 0 has a crystal structure belonging to the space group P-3 ml and includes one CoO₂ layer in a unit cell. Thus, this crystal structure is referred to as an O1 type crystal structure in some cases.

Lithium cobalt oxide with x of approximately 0.12 has the crystal structure belonging to the space group R-3m. This structure can also be regarded as a structure in which CoO₂ structures such as P-3 ml (O1) and LiCoO₂ structures such as R-3m (O3) are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 11, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (good of fitness) is smaller in Rietveld analysis of XRD patterns, for example.

When charge at a high charge voltage of 4.6 V or more with reference to the redox potential of a lithium metal or charge with a large depth with x of 0.24 or less and discharge are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 11, the CoO₂ layer in the H1-3 type crystal structure largely shifts from R-3m (O3). Such a dynamic structural change can adversely affect the stability of the crystal structure.

A difference in volume is also large. The O3 type crystal structure in a discharged state and the H1-3 type crystal structure which contain the same number of cobalt atoms have a difference in volume of more than or equal to 3.0%.

In addition, a structure in which CoO₂ layers are arranged continuously, such as P-3 ml (O1), included in the H1-3 type crystal structure is highly likely to be unstable.

Thus, the repeated high-voltage charge and discharge causes loss of the crystal structure of lithium cobalt oxide. The broken crystal structure triggers deterioration of the cycle performance. This is probably because the loss of the crystal structure reduces sites where lithium can stably exist and makes it difficult to insert and extract lithium.

### <Positive Electrode Active Material of One Embodiment of the Present Invention>

### <Inner Portion>

In the positive electrode active material 100 of one embodiment of the present invention, the shift in CoO₂ layers can be small in repeated high-voltage charge and discharge. Furthermore, the change in the volume can be small. Accordingly, the positive electrode active material of one embodiment of the present invention can enable excellent cycle performance. In addition, the positive electrode active material of one embodiment of the present invention can have a stable crystal structure in a high-voltage charged state. Thus, the positive electrode active material of one embodiment of the present invention inhibits a short circuit in some cases while the high-voltage charged state is maintained. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 9 illustrates the crystal structures of the positive electrode active material 100 before and after being charged and discharged. The positive electrode active material 100 is a composite oxide containing lithium, cobalt as the transition metal, and oxygen. In addition to the above, the positive electrode active material 100 preferably contains magnesium as the additive element X. Furthermore, the positive electrode active material 100 preferably contains halogen such as fluorine or chlorine as the additive element X.

The crystal structure with x of 1 (discharged state) in FIG. 9 is R-3m (O3), which is the same as that in FIG. 11. Meanwhile, the positive electrode active material 100 of one embodiment of the present invention with a charge depth in a sufficiently charged state includes a crystal whose structure is different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in an O3 type crystal structure. This structure is thus referred to as the O3′ type crystal structure in this specification and the like. Note that although the indication of lithium is omitted in the diagram of the O3′ type crystal structure illustrated in FIG. 9 to explain the symmetry of cobalt atoms and the symmetry of oxygen atoms, a lithium of 20 atomic % or less, for example, with respect to cobalt practically exists between the CoO₂ layers. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists at random in oxygen sites.

Note that in the O3′ type crystal structure, a light element such as lithium sometimes occupies a site coordinated to four oxygen atoms.

The O3′ type crystal structure can be regarded as a crystal structure that contains lithium between layers randomly and is similar to a CdCl₂ crystal structure. The crystal structure similar to the CdCl₂ crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

In the positive electrode active material 100 of one embodiment of the present invention, a change in the crystal structure caused when a large amount of lithium is extracted by charging with high voltage is smaller than that in a conventional positive electrode active material. As indicated by dotted lines in FIG. 9, for example, CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when charge and discharge are repeated at high voltage.

In addition, in the positive electrode active material 100, a difference in the volume per unit cell between the O3 type crystal structure with x of 1 and the O3′ type crystal structure with x of 0.2 is less than or equal to 2.5%, specifically, less than or equal to 2.2%.

Note that in the unit cell of the O3′ type crystal structure, the coordinates of cobalt and oxygen can be represented by Co (0, 0, 0.5) and 0 (0, 0, x) within the range of 0.20≤x≤0.25.

A slight amount of the additive element X such as magnesium randomly existing between the CoO₂ layers, i.e., in lithium sites, can inhibit a shift in the CoO₂ layers. Thus, magnesium between the CoO₂ layers makes it easier to obtain the O3′ type crystal structure. Therefore, magnesium is distributed in at least part of the surface portion of the positive electrode active material 100 of one embodiment of the present invention, preferably distributed throughout the surface portion of the positive electrode active material 100. To distribute magnesium throughout the surface portion of the positive electrode active material 100, heat treatment is preferably performed in the formation process of the positive electrode active material 100 of one embodiment of the present invention.

However, cation mixing occurs when the heat treatment temperature is excessively high, so that the additive element X, e.g., magnesium, is highly likely to enter the cobalt sites. Magnesium existing in the cobalt sites does not have the effect of maintaining the R-3m structure in a high-voltage charged state. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the surface portion of the positive electrode active material 100. The addition of the halogen compound decreases the melting point of lithium cobalt oxide. The decreased melting point makes it easier to distribute magnesium throughout the surface portion of the positive electrode active material 100 at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably larger than or equal to 0.001 times and less than or equal to 0.1 times, further preferably larger than 0.01 times and less than 0.04 times, still further preferably approximately 0.02 times the number of transition metal atoms such as cobalt atoms. The magnesium concentration described here may be a value obtained by element analysis on the whole of the positive electrode active material using ICP-MS or the like, or may be a value based on the ratio of the raw materials mixed in the process of forming the positive electrode active material 100, for example.

As a metal other than cobalt (hereinafter, the additive element X), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are stable when having a valence of four, and thus highly contribute to structure stability. The addition of the additive element X may enable the crystal structure to be more stable in a high-voltage charged state. The addition of the additive element X may enable the crystal structure to be more stable in a high-voltage charged state. Here, in the positive electrode active material of one embodiment of the present invention, the additive element X is preferably added at a concentration that does not greatly change the crystallinity of the lithium cobalt oxide. For example, the additive element is preferably added at an amount with which the aforementioned Jahn-Teller effect is not exhibited.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charge and discharge decreases when magnesium enters the lithium sites. When the positive electrode active material of one embodiment of the present invention contains nickel as the additive element X in addition to magnesium, the charge and discharge cycle performance can be improved in some cases. When the positive electrode active material of one embodiment of the present invention contains aluminum as the additive element X in addition to magnesium, the charge and discharge cycle performance can be improved in some cases. When the positive electrode active material of one embodiment of the present invention contains magnesium, nickel, and aluminum as the additive element X, the charge and discharge cycle performance can be improved in some cases.

The concentrations of the elements of the positive electrode active material containing magnesium, nickel, and aluminum as the additive element X are described below.

The number of nickel atoms in the positive electrode active material of one embodiment of the present invention is preferably less than or equal to 10%, further preferably less than or equal to 7.5%, and still further preferably greater than or equal to 0.05% and less than or equal to 4%, and especially preferably greater than or equal to 0.1% and less than or equal to 2% of the number of cobalt atoms. The nickel concentration described here may be a value obtained by element analysis on the whole of the positive electrode active material using ICP-MS or the like, or may be a value based on the ratio of the raw materials mixed in the process of forming the positive electrode active material, for example.

When a state being charged with high voltage is held for a long time, the constitution element of the positive electrode active material dissolves in an electrolyte solution, and the crystal structure might be broken. However, when nickel is included at the above-described proportion, dissolution of the constitution element from the positive electrode active material 100 can be inhibited in some cases.

The number of aluminum atoms in the positive electrode active material of one embodiment of the present invention is preferably greater than or equal to 0.05% and less than or equal to 4%, and further preferably greater than or equal to 0.1% and less than or equal to 2% of the number of cobalt atoms. The aluminum concentration described here may be a value obtained by element analysis on the whole of the positive electrode active material using ICP-MS or the like, or may be a value based on the ratio of the raw materials mixed in the process of forming the positive electrode active material, for example.

It is preferable that the positive electrode active material containing the additive element X of one embodiment of the present invention use phosphorus as the additive element X. The positive electrode active material of one embodiment of the present invention further preferably contains a compound containing phosphorus and oxygen.

When the positive electrode active material of one embodiment of the present invention contains a compound containing phosphorus as the additive element X, a short circuit is unlikely to occur in some cases while a high-temperature and high-voltage charged state is maintained.

When the positive electrode active material of one embodiment of the present invention contains phosphorus as the additive element X, phosphorus may react with hydrogen fluoride generated by the decomposition of the electrolyte solution, which might decrease the hydrogen fluoride concentration in the electrolyte solution.

In the case where the electrolyte solution contains LiPF₆ as a lithium salt, hydrogen fluoride might be generated by hydrolysis. In some cases, hydrogen fluoride is generated by the reaction of PVDF used as a component of the positive electrode and alkali. The decrease in hydrogen fluoride concentration in the electrolyte solution can inhibit corrosion of a current collector and/or separation of a coating film in some cases. Furthermore, the decrease in hydrogen fluoride concentration in the electrolyte solution can inhibit a reduction in adhesion properties due to gelling and/or insolubilization of PVDF in some cases.

When containing phosphorus and magnesium as the additive element X, the positive electrode active material 100 of one embodiment of the present invention is extremely stable in a high-voltage charged state. When phosphorus and magnesium are contained as the additive element X, the number of phosphorus atoms is preferably greater than or equal to 1% and less than or equal to 20%, further preferably greater than or equal to 2% and less than or equal to 10%, and still further preferably greater than or equal to 3% and less than or equal to 8% of the number of cobalt atoms. In addition, the number of magnesium atoms is preferably greater than or equal to 0.1% and less than or equal to 10%, further preferably greater than or equal to 0.5% and less than or equal to 5%, and still further preferably greater than or equal to 0.7% and less than or equal to 4% of the number of cobalt atoms. The phosphorus concentration and the magnesium concentration described here may each be a value obtained by element analysis on the whole of the positive electrode active material 100 using ICP-MS or the like, or may be a value based on the ratio of the raw materials mixed in the process of forming the positive electrode active material 100, for example.

In the case where the positive electrode active material 100 has a crack, phosphorus, more specifically, a compound containing phosphorus and oxygen, in the inner portion of the positive electrode active material with the crack may inhibit crack development, for example.

As illustrated in FIG. 9, the symmetry of the oxygen atoms slightly differs between the O3 type crystal structure and the O3′ type crystal structure. Specifically, the oxygen atoms in the O3 type crystal structure are aligned with the dotted line, whereas strict alignment of the oxygen atoms is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO₆ is distorted. In addition, repelling of oxygen atoms in the CoO₂ layer becomes stronger along with a decrease in the amount of lithium, which also affects the difference in symmetry of oxygen atoms.

<Surface Portion 100a>

It is preferable that magnesium be distributed throughout the surface portion of the positive electrode active material 100 of one embodiment of the present invention, and it is further preferable that the magnesium concentration in the surface portion 100a be higher than the average magnesium concentration in the whole. For example, the magnesium concentration in the surface portion 100a measured by XPS or the like is preferably higher than the average magnesium concentration in the whole measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in the vicinity of the surface of the particle is preferably higher than the average concentration in the whole. For example, the concentration of the element other than cobalt in the surface portion 100a measured by XPS or the like is preferably higher than the average concentration of the element in the whole measured by ICP-MS or the like.

The surface portion of the positive electrode active material 100 is a kind of crystal defects and lithium is extracted from the surface during charge; thus, the lithium concentration in the surface portion tends to be lower than that in the inner portion. Therefore, the surface tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of halogen such as fluorine in the surface portion 100a of the positive electrode active material 100 of one embodiment of the present invention is preferably higher than the average concentration in the whole. When halogen exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additive elements such as magnesium and fluorine are preferably higher than those in the inner portion. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure. Note that in this specification and the like, a structure where three layers of anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in electron diffraction or FFT (fast Fourier transform) of a TEM image or the like, a spot may appear in a position slightly different from a theoretical position. For example, anions may be regarded as forming a cubic close-packed structure when a difference in orientation from a theoretical position is 5° or less or 2.5° or less.

When a layered rock-salt crystal and a rock-salt crystal are in contact with each other, there is a crystal plane at which orientations of cubic close-packed structures composed of anions are aligned with each other.

The description can also be made as follows. Anions on the (111) plane of a cubic crystal structure has a triangular arrangement. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangular lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM (transmission electron microscope) image, a STEM (scanning transmission electron microscope) image, a HAADF-STEM (high-angle annular dark-field scanning TEM) image, an ABF-STEM (annular bright-field scanning transmission electron microscope) image, electron diffraction, and FFT of a TEM image or the like. X-ray diffraction (XRD), electron diffraction, neutron diffraction, and the like can also be used for judging.

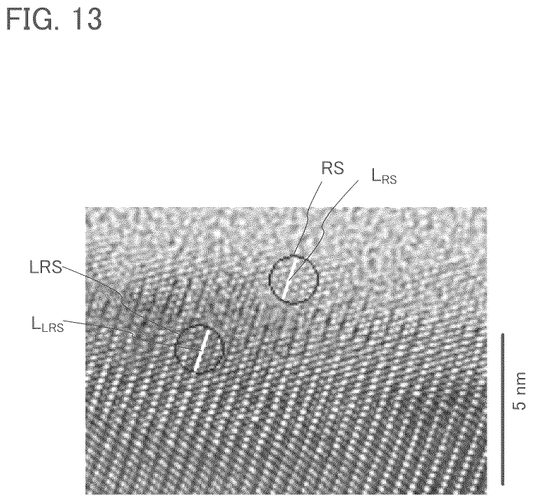

FIG. 13 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt structure, for example, a contrast derived from the (0003) plane is obtained as repetition of bright lines and dark lines because of diffraction and interference of the electron beam. Thus, when repetition of bright lines and dark lines is observed and the angle between the bright lines (e.g., L_{RS} and L_{LRS} in FIG. 13) is 5 degrees or less or 2.5 degrees or less in the TEM image, it can be judged that the crystal planes are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having the layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5 degrees or less or 2.5 degrees or less in a HAADF-STEM image, it can be judged that arrangements of the atoms are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

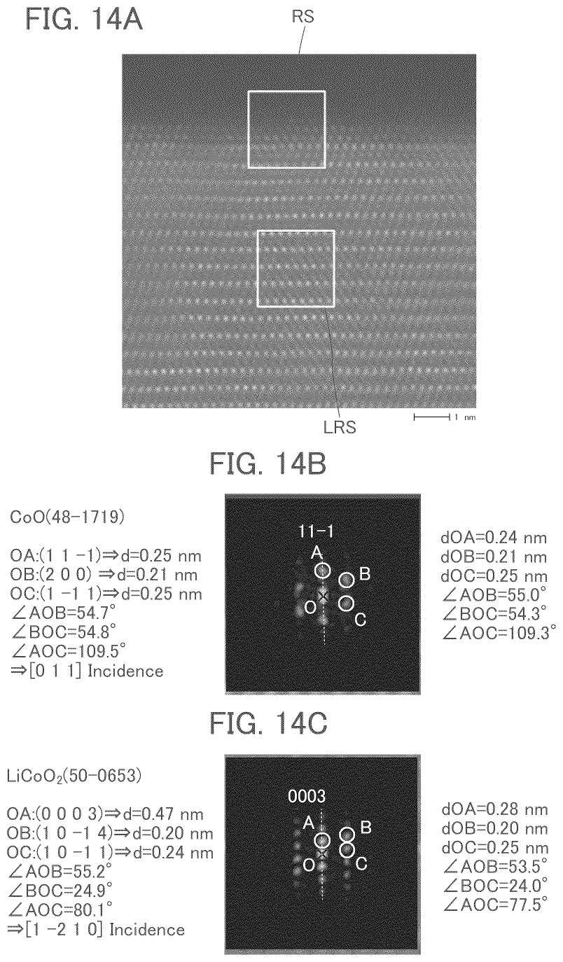

FIG. 14A shows an example of a STEM image in which orientations of the layered rock-salt crystal LRS and the rock-salt crystal RS are substantially aligned with each other. FIG. 14B shows FFT of a region of the rock-salt crystal RS, and FIG. 14C shows FFT of a region of the layered rock-salt crystal LRS. In FIG. 14B and FIG. 14C, the literature values are shown on the left, and the measured values are shown on the right. A spot denoted by O is zero-order diffraction.

A spot denoted by A in FIG. 14B is derived from 11-1 reflection of a cubic structure. A spot denoted by A in FIG. 14C is derived from 0003 reflection of a layered rock-salt structure. It is found from FIG. 14B and FIG. 14C that the direction of the 11-1 reflection of the cubic structure and the direction of the 0003 reflection of the layered rock-salt structure are substantially aligned with each other. That is, a straight line that passes through AO in FIG. 14B is substantially parallel to a straight line that passes through AO in FIG. 14C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in FFT and electron diffraction, the <0003> orientation of the layered rock-salt crystal or a plane orientation equivalent thereto and the <11-1> orientation of the rock-salt crystal or a plane orientation equivalent thereto are substantially aligned with each other in some cases. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 14C is derived from 1014 reflection of the layered rock-salt structure. This is sometimes observed at a position where the difference in orientation from the reciprocal lattice point derived from the 0003 reflection of the layered rock-salt structure (A in FIG. 14C) is greater than or equal to 52° and less than or equal to 560 (i.e., ∠AOB is 52° to 56°) and d is greater than or equal to 0.19 nm and less than or equal to 0.21 nm. Note that these indices are just examples, and the spot does not necessarily correspond with them. For example, the spot may be a reciprocal lattice point equivalent to 0003 and 1014.

Similarly, a spot that is not derived from the 11-1 of the cubic structure may be observed on a reciprocal lattice space different from the direction where the 11-1 of the cubic structure is observed. For example, a spot denoted by B in FIG. 14B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 14B) is greater than or equal to 540 and less than or equal to 560 (i.e., ∠AOB is 54° to 56°). Note that these indices are just examples, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin using FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The additive element X is preferably positioned in the surface portion 100a of the particle of the positive electrode active material 100 of one embodiment of the present invention. For example, the positive electrode active material 100 of one embodiment of the present invention may be covered with the coating film containing the additive element X.

### <Grain Boundary>

The additive element X included in the positive electrode active material 100 of one embodiment of the present invention may randomly exist in the inner portion at a slight concentration, but part of the additive element is preferably segregated in a grain boundary.

In other words, the concentration of the additive element Xin the crystal grain boundary and its vicinity of the positive electrode active material 100 of one embodiment of the present invention is preferably higher than that in the other regions in the inner portion.

The crystal grain boundary can be regarded as a plane defect. Thus, the crystal grain boundary tends to be unstable and the crystal structure easily starts to change like the surface of the particle. Therefore, when the concentration of the added element X in the crystal grain boundary and its vicinity is higher, the change in the crystal structure can be inhibited more effectively.

In the case where the concentration of the additive element X is high in the crystal grain boundary and its vicinity, even when a crack is generated along the crystal grain boundary of the particle of the positive electrode active material 100 of one embodiment of the present invention, the concentration of the additive element X is increased in the vicinity of the surface generated by the crack. Thus, the positive electrode active material can have an increased corrosion resistance to hydrofluoric acid even after a crack is generated.

Note that in this specification and the like, the vicinity of the crystal grain boundary refers to a region within approximately 10 nm from the grain boundary.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 m, further preferably greater than or equal to 2 m and less than or equal to 40 m, still further preferably greater than or equal to 5 m and less than or equal to 30 m.

### <Analysis Method>

Whether or not a positive electrode active material is the positive electrode active material 100 of one embodiment of the present invention that has an O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high-voltage charged state and a discharged state. A material 50 wt % or more of which has the crystal structure that largely changes between a high-voltage charged state and a discharged state is not preferable because the material cannot withstand high-voltage charge and discharge. In addition, it should be noted that an objective crystal structure is not obtained in some cases only by addition of additive elements. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged at a high voltage. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <Charge Method>

High-voltage charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive agent, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is charged with constant current at 4.6 V and 0.5 C and then charged with constant voltage until the current value reaches 0.01 C. Note that here, 1 C is set to 137 mA/g. The temperature is set to 25° C. After the charge is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode active material enclosed in an airtight container with an argon atmosphere.

### <XRD>

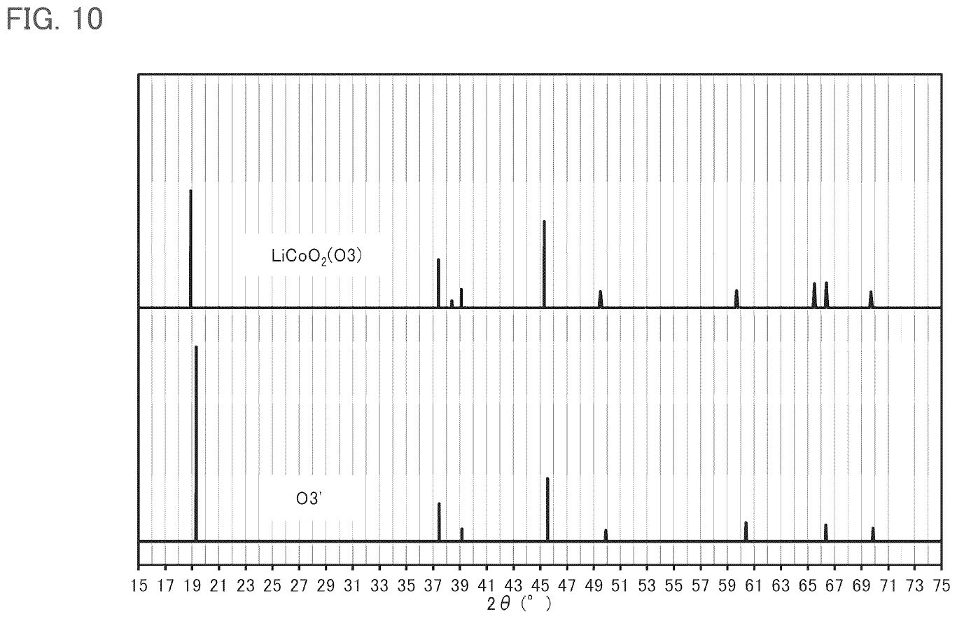

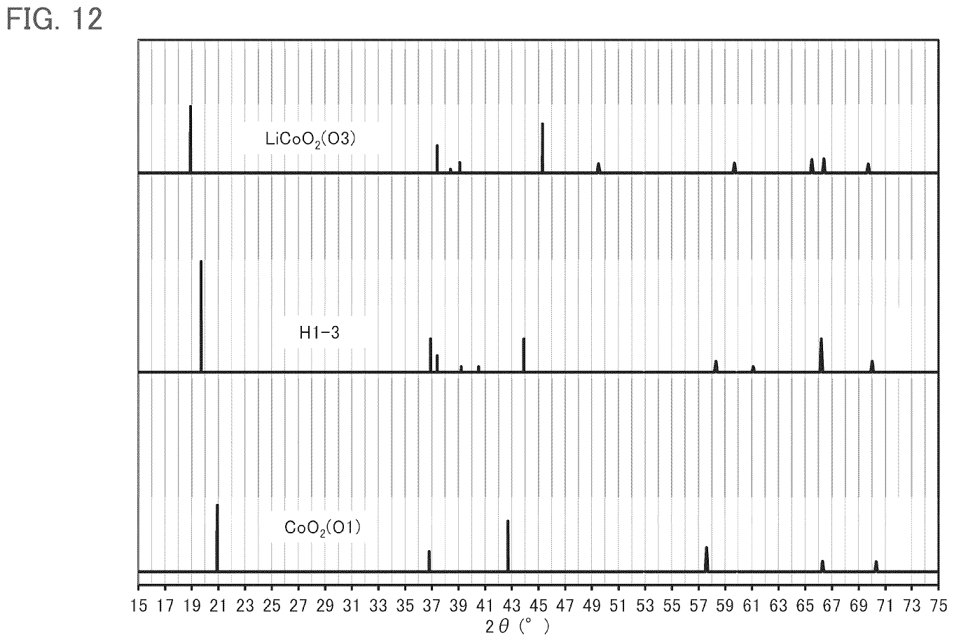

FIG. 10 and FIG. 12 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with x of 1 and the crystal structure of CoO₂ (O1) with x of 0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The pattern of the O3′ type crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 10, the O3′ type crystal structure exhibits diffraction peaks at 2θ of 19.30±0.20° (greater than or equal to 19.10° and less than or equal to 19.50°) and 2θ of 45.55±0.100 (greater than or equal to 45.450 and less than or equal to 45.65°). More specifically, sharp diffraction peaks appear at 2θ of 19.30±0.10° (greater than or equal to 19.200 and less than or equal to 19.40°) and 2θ of 45.55±0.05° (greater than or equal to 45.500 and less than or equal to 45.60°). By contrast, as shown in FIG. 12, the H1-3 type crystal structure and CoO₂ (P-3 ml, O1) do not exhibit peaks at these positions. Thus, the peaks at 2θ of 19.30±0.20° and 2θ of 45.55±0.10° in a high-voltage charged state can be the features of the positive electrode active material 100 of one embodiment of the present invention.

It can be said that the positions of the XRD diffraction peaks exhibited by the crystal structure with x of 1 are close to those of the XRD diffraction peaks exhibited by the crystal structure in a high-voltage charged state. More specifically, it can be said that a difference in the positions of two or more, preferably three or more of the main diffraction peaks between the crystal structures is 2θ=0.7 or less, preferably 2θ=0.5 or less.

Although the positive electrode active material 100 of one embodiment of the present invention has the O3′ type crystal structure when charged with high voltage, the entire crystal structure of the positive electrode active material 100 is not necessarily the O3′ type crystal structure. The positive electrode active material 100 may have another crystal structure or be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charge and discharge after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, a clear peak of the O3′ type crystal structure can be observed in a high-voltage charged state, even under the same XRD measurement conditions as those of a positive electrode before the charge and discharge. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described additive element Xin addition to cobalt as long as the influence of the Jahn-Teller effect is small.

Preferable ranges of the lattice constants of the positive electrode active material of one embodiment of the present invention are examined. In the layered rock-salt crystal structure of the particle of the positive electrode active material in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be the state of a powder before the formation of a positive electrode of a secondary battery.

Alternatively, in the layered rock-salt crystal structure of the particle of the positive electrode active material in the discharged state or the state where charge and discharge are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charge and discharge are not performed is subjected to XRD analysis, a first peak is observed at 2θ of greater than or equal to 18.500 and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### <XPS>

A region that is approximately 2 to 8 nm (normally, approximately 5 nm) in depth from a surface can be analyzed by X-ray photoelectron spectroscopy (XPS); thus, the concentration of each element in approximately half of the surface portion 100a can be quantitatively analyzed. The bonding states of the elements can be analyzed by narrow scanning. Note that the quantitative accuracy of XPS is approximately ±1 atomic % in many cases, and the lower detection limit is approximately 1 atomic % but depends on the element.

When the positive electrode active material 100 of one embodiment of the present invention is subjected to XPS analysis, the number of atoms of the additive element X is preferably greater than or equal to 1.6 times and less than or equal to 6.0 times, further preferably greater than or equal to 1.8 times and less than 4.0 times the number of atoms of the transition metal. When the additive element X is magnesium and the transition metal M1 is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal.

In the XPS analysis, monochromatic aluminum can be used as an X-ray source, for example. An extraction angle is, for example, 45°.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from both the bonding energy of lithium fluoride, which is 685 eV, and the bonding energy of magnesium fluoride, which is 686 eV. That is, in the case where the positive electrode active material 100 of one embodiment of the present invention contains fluorine, the fluorine is preferably in a bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride, which is 1305 eV, and close to the bonding energy of magnesium oxide. That is, in the case where the positive electrode active material 100 of one embodiment of the present invention contains magnesium, the magnesium is preferably in a bonding state other than magnesium fluoride.

The concentration of the additive element X that preferably exists in the surface portion 100a in a large amount, such as magnesium or aluminum, measured by XPS or the like is preferably higher than the concentration measured by ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion 100a are preferably higher than that in the inner portion 100b. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals, not be unevenly distributed in the surface portion 100a but be distributed in the entire positive electrode active material 100. Note that one embodiment of the present invention is not limited thereto in the case where the above-described region where the excess additive element X is unevenly distributed exists.

### <Surface Roughness and Specific Surface Area>

The positive electrode active material 100 of one embodiment of the present invention preferably has a smooth surface with little unevenness. A smooth surface with little unevenness indicates favorable distribution of the additive element X in the surface portion 100a. For the positive electrode active material 100, it is particularly preferable to perform initial heating on lithium cobalt oxide or lithium nickel-cobalt-manganese oxide before the addition of the additive element X in the formation process of the positive electrode active material 100, in which case remarkably excellent repeated charge and discharge performance at high voltage is exhibited.

When the positive electrode active material 100 has a smooth surface with little unevenness, the surface of the positive electrode active material 100 can be more stable and generation of a pit can be inhibited.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness in at least 400 nm of the particle periphery of the positive electrode active material.

On the particle surface of the positive electrode active material 100 of this embodiment, root-mean-square (RMS) surface roughness, which is an index of roughness, is less than or equal to 10 nm, less than 3 nm, preferably less than 1 nm, further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.

The contents in this embodiment can be freely combined with the contents in the other embodiments.

### Embodiment 3

In this embodiment, a method for forming the positive electrode active material 100 of one embodiment of the present invention is described.

### <<Method 1 for Forming Positive Electrode Active Material>>

### <Step S11>

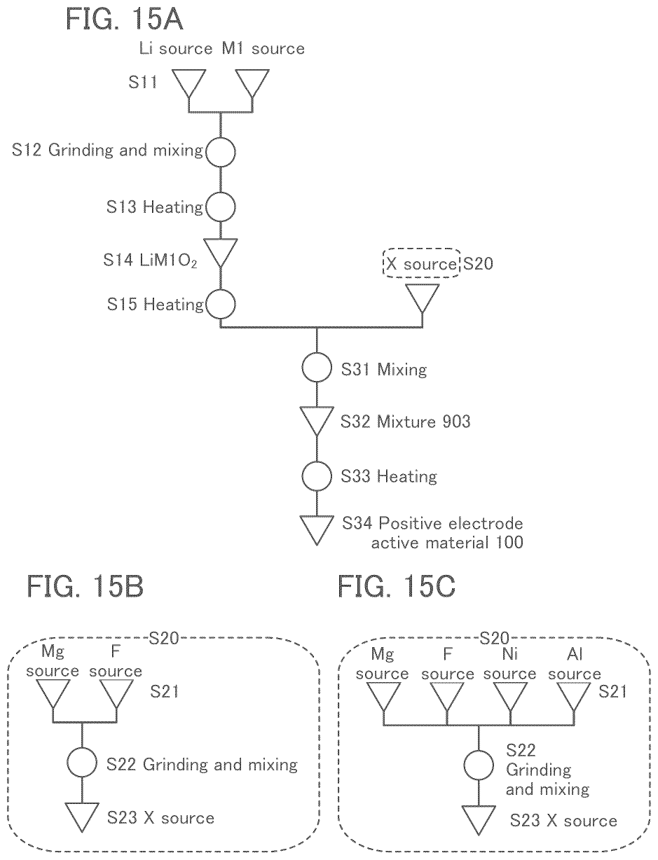

In Step S11 shown in FIG. 15A, a lithium source (Li source) and a transition metal source (M1 source) are prepared as materials of lithium and a transition metal which are starting materials.

A compound containing lithium is preferably used as the lithium source; for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal M1 can be selected from the elements belonging to Groups 4 to 13 of the periodic table and for example, at least one of manganese, cobalt, and nickel is used. As the transition metal, for example, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel cobalt manganese oxide (NCM).

As a transition metal M1 source, a compound containing the above transition metal is preferably used and for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal M1 source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using the high-purity material. As a result, a secondary battery with an increased capacity and/or increased reliability can be obtained.

Furthermore, the transition metal M1 source preferably has high crystallinity, and preferably includes single crystal particles, for example. To evaluate the crystallinity of the transition metal source, for example, the crystallinity can be judged by a TEM (transmission electron microscope) image, an STEM (scanning transmission electron microscope) image, a HAADF-STEM (high-angle annular dark field scanning transmission electron microscope) image, an ABF-STEM (annular bright-field scan transmission electron microscope) image, or the like, or can be judged by X-ray diffraction (XRD), electron diffraction, neutron diffraction, or the like. Note that the above method for evaluating crystallinity can also be employed to evaluate crystallinity of materials other than the transition metal source.

In the case of using two or more transition metal sources, the two or more transition metal M1 sources are preferably prepared to have proportions (mixing ratio) such that a layered rock-salt crystal structure would be obtained.

### <Step S12>

Next, in Step S12 shown in FIG. 15A, the lithium source and the transition metal M1 source are ground and mixed to form a mixed material. The grinding and mixing can be performed by a dry process or a wet process. A wet method is preferred because it can crush a material into a smaller size. When the mixing is performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used. It is suitable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the media. In this embodiment, the peripheral speed is set to 838 mm/s (the rotational frequency is 400 rpm, and the ball mill diameter is 40 mm).

### <Step S13>

Next, the materials mixed in the above manner are heated in Step S13 shown in FIG. 15A. The heating is preferably performed at higher than or equal to 800° C. and lower than or equal to 1100° C., further preferably higher than or equal to 900° C. and lower than or equal to 1000° C., and still further preferably approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is longer than or equal to 1 hour and shorter than or equal to 100 hours, preferably longer than or equal to 2 hours and shorter than or equal to 20 hours.

The temperature raising rate is preferably higher than or equal to 80° C./h and lower than or equal to 250° C./h, although depending on the end-point temperature of the heating. For example, in the case of heating at 1000° C. for 10 hours, the temperature rise is preferably at 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. The heating with a rotary kiln can be performed while stirring is performed in either case of a sequential rotary kiln or a batch-type rotary kiln.

A crucible used at the time of the heating is preferably an alumina crucible. An alumina crucible is made of a material that hardly releases impurities. In this embodiment, a crucible made of alumina with a purity of 99.9% is used. A crucible is preferably heated with a cover put thereon. Volatilization of the materials can be prevented.

The heated material is ground as needed and may be made to pass through a sieve. Before collection of the heated material, the material may be moved from the crucible to a mortar. As the mortar, an alumina mortar can be suitably used. An alumina mortar is made of a material that hardly releases impurities. Specifically, a mortar made of alumina with a purity of 90% or higher, preferably 99% or higher, is used. Note that heating conditions equivalent to those in Step S13 can be employed in a later-described heating step other than Step S13.

### <Step S14>

Through the above steps, a composite oxide containing the transition metal (LiM1O₂) can be obtained in Step S14 shown in FIG. 15A. The composite oxide needs to have a crystal structure of a lithium composite oxide represented by LiM102, but the composition is not strictly limited to Li:M1:0=1:1:2. When the transition metal is cobalt, the composite oxide is referred to as a composite oxide containing cobalt and is represented by LiCoO₂. The composition is not strictly limited to Li:Co:0=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 15A, the above composite oxide is heated. The heating in Step S15 is the first heating performed on the composite oxide and thus, this heating is sometimes referred to as the initial heating. Through the initial heating, the surface of the composite oxide becomes smooth. A smooth surface refers to a state where the composite oxide has little unevenness and is rounded as a whole and its corner portion is rounded. Being smooth refers to a state where few foreign matters are attached to the surface. Foreign matters are deemed to cause unevenness and are preferably not attached to a surface.

The initial heating is heating performed after a composite oxide is obtained, and the present inventors have found that the initial heating for making the surface smooth can reduce degradation after charge and discharge. The initial heating for making the surface smooth does not need a lithium compound source.

Alternatively, the initial heating for making the surface smooth does not need an added element source.

Alternatively, the initial heating for making the surface smooth does not need a flux.

The initial heating is performed before Step S20 described below and is sometimes referred to as preheating or pretreatment.

The lithium source and the transition metal source prepared in Step S11 and the like might contain impurities. The initial heating can reduce impurities in the composite oxide completed in Step 14.

The heating conditions in this step can be freely set as long as the heating makes the surface of the above composite oxide smooth. For example, any of the heating conditions described for Step S13 can be selected. Additionally, the heating temperature in this step is preferably lower than the temperature in Step S13 so that the crystal structure of the composite oxide is maintained. The heating time in this step is preferably shorter than the time in Step S13 so that the crystal structure of the composite oxide is maintained. For example, the heating is preferably performed at a temperature of higher than or equal to 700° C. and lower than or equal to 1000° C. for longer than or equal to 2 hours.

The heating in Step S13 might cause a temperature difference between the surface and an inner portion of the composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth, or “surface improvement is achieved”, through Step S15. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift in a crystal or the like which is caused in the composite oxide to make the surface of the composite oxide smooth.

In a secondary battery including a composite oxide with a smooth surface as a positive electrode active material, degradation by charge and discharge is suppressed and a crack in the positive electrode active material can be prevented.

It can be said that when surface unevenness information in one cross section of a composite oxide is converted into numbers with measurement data, a smooth surface of the composite oxide has a surface roughness of less than or equal to 10 nm. The one cross section is, for example, a cross section obtained in observation using a scanning transmission electron microscope (STEM).

Note that a composite oxide containing lithium, the transition metal, and oxygen, synthesized in advance may be used in Step S14. In this case, Step S11 to Step S13 can be omitted. When Step S15 is performed on the pre-synthesized composite oxide, a composite oxide with a smooth surface can be obtained.

The initial heating might decrease lithium in the composite oxide. An additive element described for Step S20 below might easily enter the composite oxide owing to the decrease in lithium.

### <Step S20>

The additive element X may be added to the composite oxide having a smooth surface as long as a layered rock-salt crystal structure can be obtained. When the additive element X is added to the composite oxide having a smooth surface, the additive element can be uniformly added. It is thus preferable that the initial heating precede the addition of the additive element. The step of adding the additive element is described with reference to FIG. 15B and FIG. 15C.

### <Step S21>

In Step S21 shown in FIG. 15B, additive element sources to be added to the composite oxide are prepared. A lithium source may be prepared together with the additive element sources.

As the additive element, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium can be used. Note that the aforementioned additive elements are more suitable because bromine and beryllium are elements having toxicity to living things.

When magnesium is selected as the additive element, the additive element source can be referred to as a magnesium source. As the magnesium source, for example, magnesium fluoride, magnesium oxide, magnesium hydroxide, or magnesium carbonate can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating step described later.

In addition, magnesium fluoride can be used as both the fluorine source and the magnesium source. Lithium fluoride can also be used as the lithium source. Another example of the lithium source that can be used in Step S21 is lithium carbonate.

The fluorine source may be a gas, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of reducing the melting point becomes the highest. On the other hand, when the amount of lithium fluoride increases, cycle performance might deteriorate because of a too large amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the vicinity means a value greater than 0.9 times and less than 1.1 times a certain value.

### <Step S22>

Next, in Step S22 shown in FIG. 15B, the magnesium source and the fluorine source are ground and mixed. Any of the conditions for the grinding and mixing that are described for Step S12 can be selected to perform this step.

A heating step may be performed after Step S22 as needed. For the heating step, any of the heating conditions described for Step S13 can be selected. The heating time is preferably longer than or equal to 2 hours and the heating temperature is preferably higher than or equal to 800° C. and lower than or equal to 1100° C.

### <Step S23>

Next, in Step S23 shown in FIG. 15B, the materials ground and mixed in the above step are collected to obtain the additive element source (X source). Note that the additive element source in Step S23 contains a plurality of starting materials and can be referred to as a mixture.

As for the particle diameter of the mixture, its D50 (median diameter) is preferably greater than or equal to 10 nm and less than or equal to 20 m, further preferably greater than or equal to 100 nm and less than or equal to 5 m. Also when one kind of material is used as the added element source, the D50 (median diameter) is preferably greater than or equal to 10 nm and less than or equal to 20 m, further preferably greater than or equal to 100 nm and less than or equal to 5 m.

Such a pulverized mixture (which may contain only one kind of the additive element) is easily attached to the surface of a composite oxide particle uniformly in a later step of mixing with the composite oxide. The mixture is preferably attached uniformly to the surface of the composite oxide, in which case both fluorine and magnesium are easily distributed or dispersed uniformly in a surface portion of the composite oxide after heating. The region where fluorine and magnesium are distributed can also be referred to as a surface portion. When there is a region containing neither fluorine nor magnesium in the surface portion, the positive electrode active material might be less likely to have an O3′ type crystal structure, which is described later, in the charged state. Note that although fluorine is used in the above description, chlorine may be used instead of fluorine, and a general term “halogen” for these elements can be replaced with “fluorine”.

### <Step S21>

A process different from that in FIG. 15B is described with reference to FIG. 15C. In Step S21 shown in FIG. 15C, four kinds of additive element sources to be added to the composite oxide are prepared. In other words, FIG. 15C is different from FIG. 15B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source)) are prepared. Note that the magnesium source and the fluorine source can be selected from the compounds and the like described with reference to FIG. 15B. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 15C are similar to the steps described with reference to FIG. 15B.

### <Step S31>

Next, in Step S31 shown in FIG. 15A, the composite oxide and the additive element source (X source) are mixed. The ratio of the number of transition metal M1 atoms (M1) in the composite oxide containing lithium, the transition metal, and oxygen to the number of magnesium atoms (Mg) in the additive element X source is preferably M1:Mg=100:y (0.1≤y≤6), further preferably M1:Mg=100:y (0.3≤y≤53).

The conditions of the mixing in Step S31 are preferably milder than those of the mixing in Step S12 in order not to damage the particles of the composite oxide. For example, conditions with a lower rotation frequency or shorter time than the mixing in Step S12 are preferable. In addition, it can be said that the dry process has a milder condition than the wet process. For example, a ball mill, a bead mill, or the like can be used for the mixing. When a ball mill is used, zirconia balls are preferably used as media, for example.

In this embodiment, the mixing is performed with a ball mill using zirconia balls with a diameter of 1 mm by a dry process at 150 rpm for 1 hour. The mixing is performed in a dry room with a dew point higher than or equal to −100° C. and lower than or equal to −10° C.

### <Step S32>

Next, in Step S32 of FIG. 15A, the materials mixed in the above manner are collected to obtain the mixture 903. At the time of collection, the materials may be sieved as needed after being crushed.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal source in Step S11, i.e., at the stage of the starting materials of the composite oxide. Then, the heating in Step S13 is performed, so that LiM1O₂ to which magnesium and fluorine are added can be obtained. In that case, there is no need to separate steps of Step S11 to Step S14 and steps of Step S21 to Step S23, which is simple and productive.

Alternatively, lithium cobalt oxide to which magnesium and fluorine are added in advance may be used. When lithium cobalt oxide to which magnesium and fluorine are added is used, Step S11 to Step S32 and Step S20 can be omitted, so that the method is simplified and enables increased productivity.

Alternatively, to lithium cobalt oxide to which magnesium and fluorine are added in advance, a magnesium source and a fluorine source or a magnesium source, a fluorine source, a nickel source, and an aluminum source may be further added as in Step S20.

### <Step S33>

Then, in Step S33 shown in FIG. 15A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiM1O₂) and the additive element source proceeds. The temperature at which the reaction proceeds is the temperature at which interdiffusion of the elements included in LiM1O₂ and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element source, the eutectic point of LiF and MgF₂ is around 742° C., and the lower limit of the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiM1O₂ (the decomposition temperature of LiCoO₂ is 1130° C.). At around the decomposition temperature, a slight amount of LiM1O₂ might be decomposed. Thus, the heating temperature is preferably lower than or equal to 1000° C., further preferably lower than or equal to 950° C., and further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., and yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., and yet still further preferably higher than or equal to 742° C. and lower than or equal to 900° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., and yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating the fluorine source or the like is preferably controlled to be within an appropriate range.

In the formation method described in this embodiment, some of the materials, e.g., LiF as the fluorine source, function as a flux in some cases. Owing to this function, the heating temperature can be lower than the decomposition temperature of the composite oxide (LiM1O₂), e.g., a temperature higher than or equal to 742° C. and lower than or equal to 950° C., which allows distribution of the additive element such as magnesium in the surface portion and formation of the positive electrode active material having favorable performance.

However, since LiF in a gas phase has a specific gravity less than that of oxygen, heating might volatilize LiF and in that case, LiF in the mixture 903 decreases. As a result, the function of a flux deteriorates. Thus, heating needs to be performed while volatilization of LiF is inhibited. Note that even when LiF is not used as the fluorine source or the like, Li at the surface of LiM1O₂ and F of the fluorine source might react to produce LiF, which might volatilize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions, such as the heating temperature, and the particle size and composition of LiM1O₂ in Step S14. In the case where the size of LiM1O₂ is small, it is sometimes preferable that the heating be performed at a lower temperature or for a shorter time than the case where the size of LiM1O₂ is large.

When the median diameter (D50) of the composite oxide (LiM1O₂) in Step S14 in FIG. 15A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

When the median diameter (D50) of the composite oxide (LiM1O₂) in Step S14 is approximately 5 m, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 15A, in which crushing is performed as needed; thus, the positive electrode active material 100 is obtained. Here, the collected particles are preferably made to pass through a sieve. Through the above steps, the positive electrode active material 100 of one embodiment of the present invention can be formed. The positive electrode active material of one embodiment of the present invention has a smooth surface.

### <<Method 2 for Forming Positive Electrode Active Material>>

Next, as one embodiment of the present invention, a method different from the method 1 for forming a positive electrode active material will be described.

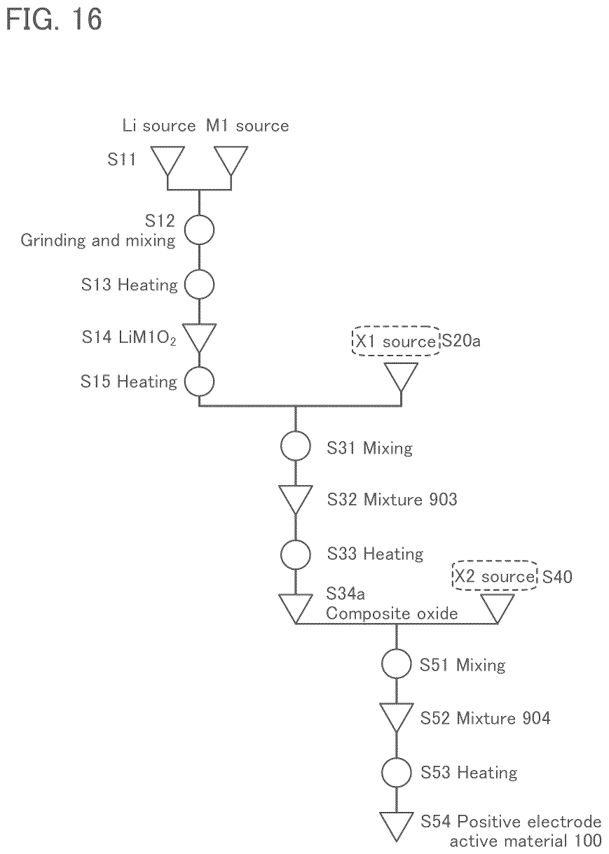

Steps S11 to S15 in FIG. 16 are performed as in FIG. 15A to prepare a composite oxide (LiM1O₂) having a smooth surface.

### <Step S20a>

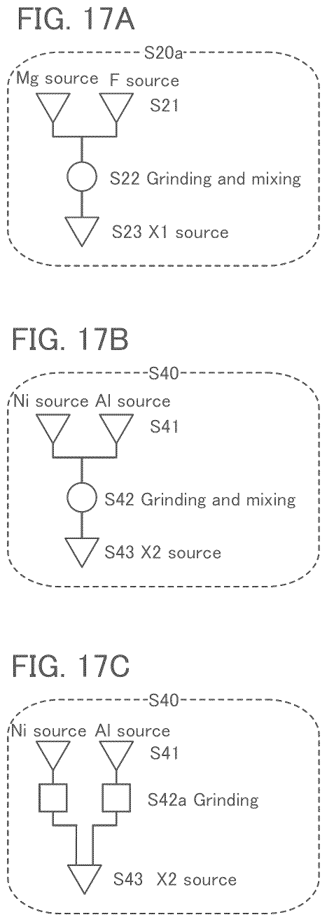

As already described above, the additive element X may be added to the composite oxide as long as a layered rock-salt crystal structure can be obtained. The formation method 2 has two or more steps of adding the additive element, as described below with reference to FIG. 17A.

### <Step S21>

In Step S21 shown in FIG. 17A, a first additive element source is prepared. The first additive element source can be selected from the additive elements X described for Step S21 with reference to FIG. 15B to be used. For example, any one or more selected from magnesium, fluorine, and calcium can be suitably used for the additive element XL. FIG. 17A shows an example of using a magnesium source (Mg source) and a fluorine source (F source) as the additive element X.

Step S21 to Step S23 shown in FIG. 17A can be performed under the same conditions as those in Step S21 to Step S23 shown in FIG. 15B. As a result, the additive element source (X1 source) can be obtained in Step S23.

Steps S31 to S33 shown in FIG. 16 can be performed in a manner similar to that of Steps S31 to S33 shown in FIG. 15A.

### <Step S34a>

Next, the material heated in Step S33 is collected to form a composite oxide containing the additive element XL. This composite oxide is called a second composite oxide to be distinguished from the composite oxide in Step S14.

### <Step S40>

In Step S40 shown in FIG. 16, a second additive element source is added. Descriptions are given also with reference to FIG. 17B and FIG. 17C.

### <Step S41>

In Step S41 shown in FIG. 17B, the second additive element source is prepared. The second additive element source can be selected from the above-described additive elements X described for Step S21 shown in FIG. 15B. For example, any one or more selected from nickel, titanium, boron, zirconium, and aluminum can be suitably used for the additive element X2. FIG. 17B shows an example of using nickel and aluminum for the additive element source X2.

Step S41 to Step S43 shown in FIG. 17B can be performed under the same conditions as those in Step S21 to Step S23 shown in FIG. 15B. As a result, the additive element source (X2 source) can be obtained in Step S43.

FIG. 17C shows a variation example of the steps which are described with reference to FIG. 17B. A nickel source (Ni source) and an aluminum source (Al source) are prepared in Step S41 shown in FIG. 17C and are separately ground in Step S42a. Accordingly, a plurality of second additive element sources (X2 sources) are prepared in Step S43. FIG. 17C is different from FIG. 17B in separately grinding the additive elements in Step S42a.

### <Step S51 to Step S54>

Next, Step S51 to Step S53 shown in FIG. 16 can be performed under the same conditions as those in Step S31 to Step S33 shown in FIG. 15A. The heating in Step S53 can be performed at a lower temperature and for a shorter time than the heating in Step S33. Through the above steps, the positive electrode active material 100 of one embodiment of the present invention can be formed in Step S54. The positive electrode active material of one embodiment of the present invention has a smooth surface.

As shown in FIG. 16 and FIG. 17, in the formation method 2, introduction of the additive element to the composite oxide is separated into introduction of the first additive element X1 and that of the second additive element X2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the added element to the composite oxide, the adding step is preferably performed after the initial heating. The adding step may be separated into two or more steps. Such an order of steps is preferred in order to maintain the smoothness of the surface achieved by the initial heating. When a composite oxide contains cobalt as a transition metal, the composite oxide can be read as a composite oxide containing cobalt.

This embodiment can be used in combination with the other embodiments.

### Embodiment 4

This embodiment will describe examples of shapes of several types of secondary batteries including a positive electrode or a negative electrode formed by the fabrication method described in the foregoing embodiment.

### [Coin-Type Secondary Battery]

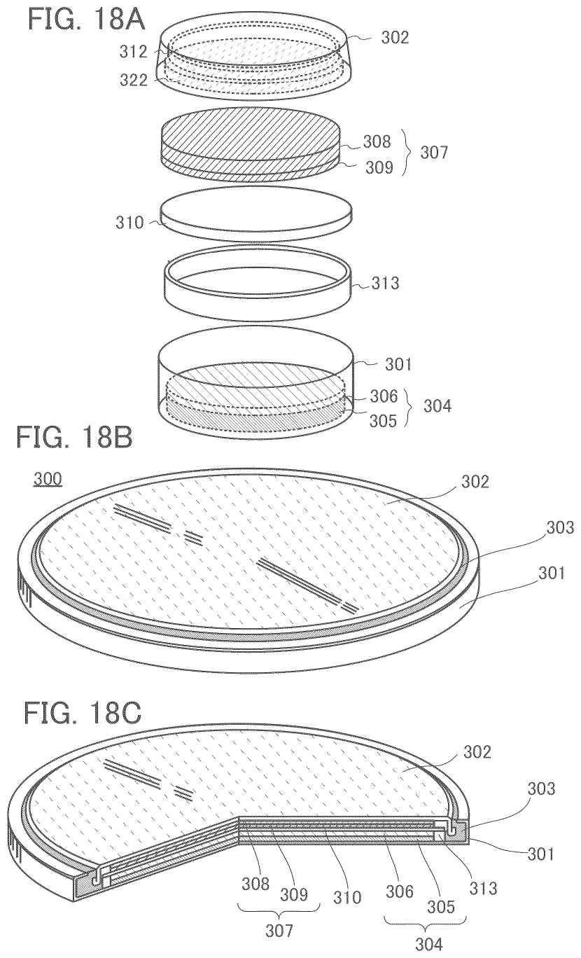

An example of a coin-type secondary battery will be described. FIG. 18A is an exploded perspective view of a coin-type (single-layer flat) secondary battery, FIG. 18B is an external view, and FIG. 18C is a cross-sectional view thereof. Coin-type secondary batteries are mainly used in small electronic devices. In this specification and the like, coin-type batteries include button-type batteries.

For easy understanding, FIG. 18A is a schematic view illustrating overlap (a vertical relation and a positional relation) between components. Thus, FIG. 18A and FIG. 18B do not completely correspond with each other.

In FIG. 18A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 18A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 18B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 18C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have high capacity, high charge and discharge capacity, and excellent cycle performance. Note that in the case where a secondary battery including a solid electrolyte layer is provided between provided between the negative electrode 307 and the positive electrode 304, the separator 310 can be unnecessary.

### [Cylindrical Secondary Battery]

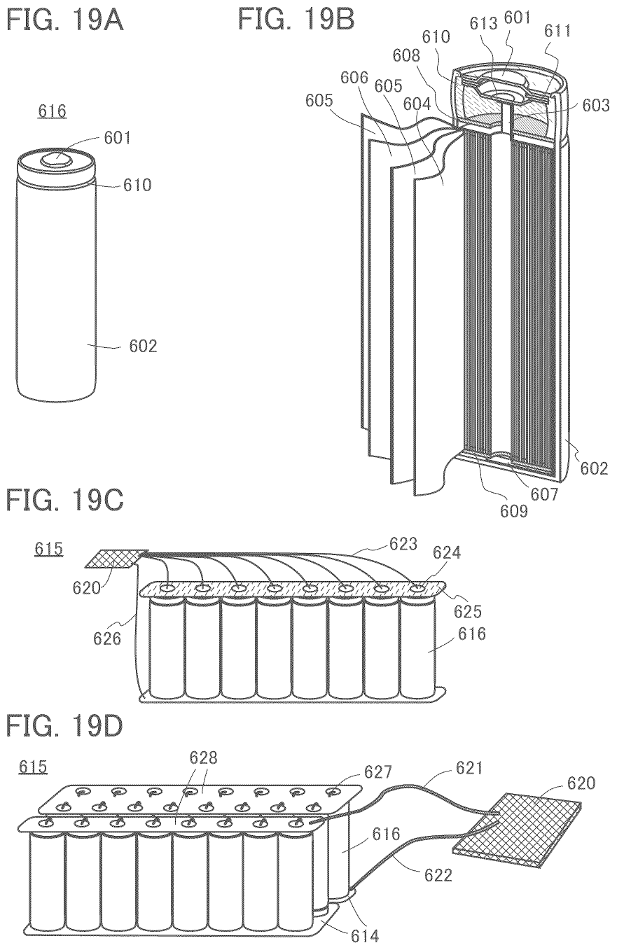

An example of a cylindrical secondary battery is described with reference to FIG. 19A. As illustrated in FIG. 19A, a cylindrical secondary battery 616 includes a positive electrode cap (battery cap) 601 on the top surface and a battery can (outer can) 602 on the side surface and the bottom surface. The positive electrode cap 601 and the battery can (outer can) 602 are insulated from each other by a gasket (insulating gasket) 610.

FIG. 19B schematically illustrates a cross section of a cylindrical secondary battery. The cylindrical secondary battery illustrated in FIG. 19B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. Although FIG. 19A to FIG. 19D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material composite 100z obtained in the foregoing embodiment is used in the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 19C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 19D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 19D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

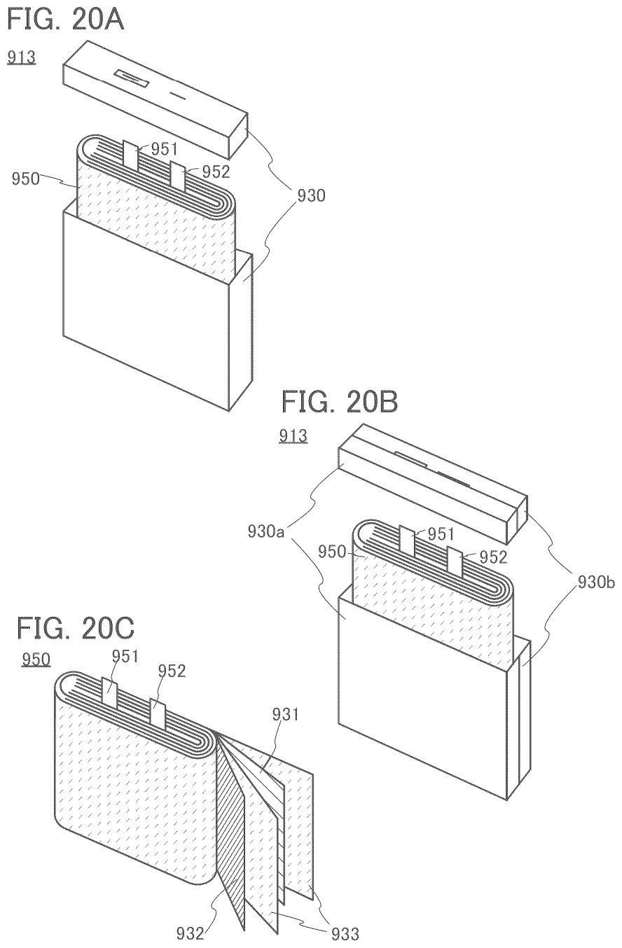

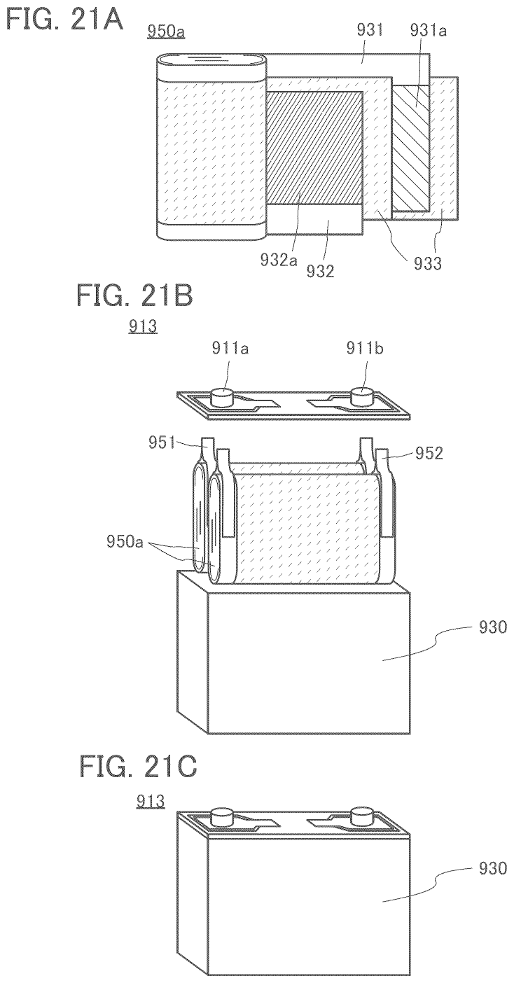

Structure examples of secondary batteries are described with reference to FIG. 20 and FIG. 21.

A secondary battery 913 illustrated in FIG. 20A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 20A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 20B, the housing 930 illustrated in FIG. 20A may be formed using a plurality of materials. For example, in the secondary battery 913 in FIG. 20B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 20C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIG. 21A to FIG. 21C, the secondary battery 913 may include a wound body 950a. The wound body 950a illustrated in FIG. 21A includes the negative electrode 931, the positive electrode 932, and the separators 933. The negative electrode 931 includes a negative electrode active material layer 931a. The positive electrode 932 includes a positive electrode active material layer 932a.

The positive electrode active material composite 100z obtained in the foregoing embodiment is used in the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 21B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 21C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 21B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 20A to FIG. 20C can be referred to for the other components of the secondary battery 913 illustrated in FIG. 21A and FIG. 21B.

### <Laminated Secondary Battery>

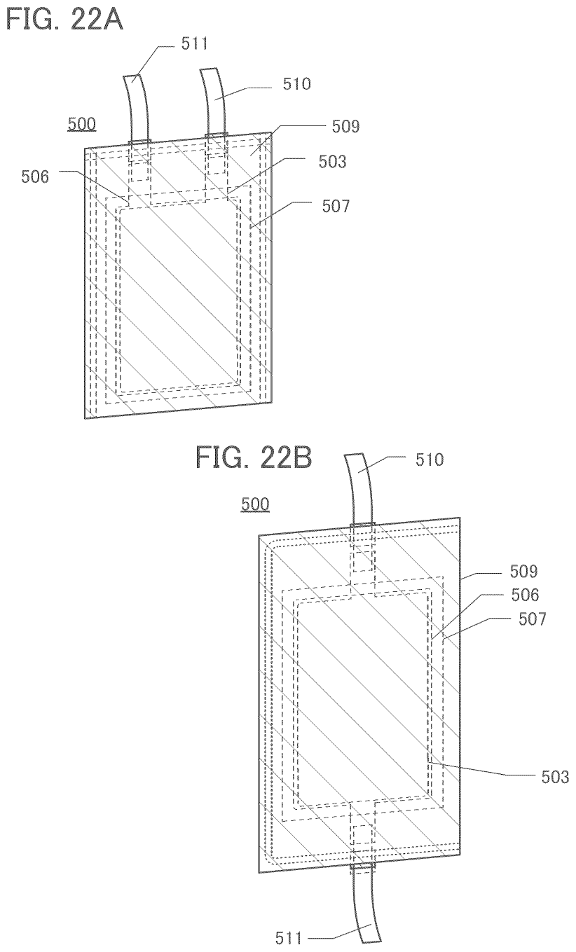

Next, examples of the appearance of a laminated secondary battery are illustrated in FIG. 22A and FIG. 22B. FIG. 22A and FIG. 22B each illustrate a positive electrode 503, a negative electrode 506, a separator 507, an exterior body 509, a positive electrode lead electrode 510, and a negative electrode lead electrode 511.

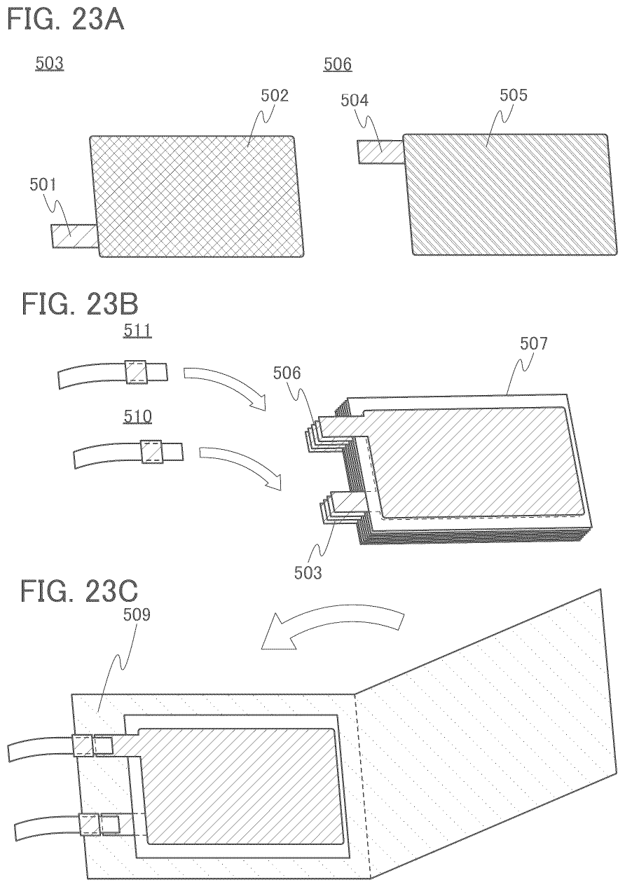

FIG. 23A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 23A.

### <Method for Fabricating Laminated Secondary Battery>

Here, an example of a method for fabricating the laminated secondary battery having the appearance illustrated in FIG. 22A will be described with reference to FIG. 23B and FIG. 23C.

First, the negative electrode 506, the separator 507, and the positive electrode 503 are stacked. FIG. 23B illustrates the negative electrodes 506, the separators 507, and the positive electrodes 503 that are stacked. Here, an example in which 5 negative electrodes and 4 positive electrodes are used is illustrated. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 23C. Then, the outer edges of the exterior body 509 are bonded to each other. The bonding can be performed by thermocompression, for example. At this time, a part (or one side) of the exterior body 509 is left unbonded (such part is hereinafter referred to as an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material composite 100z obtained in the foregoing embodiment is used in the positive electrode 503, whereby the secondary battery 500 can have high capacity, high charge and discharge capacity, and excellent cycle performance.

### [Examples of Battery Pack]

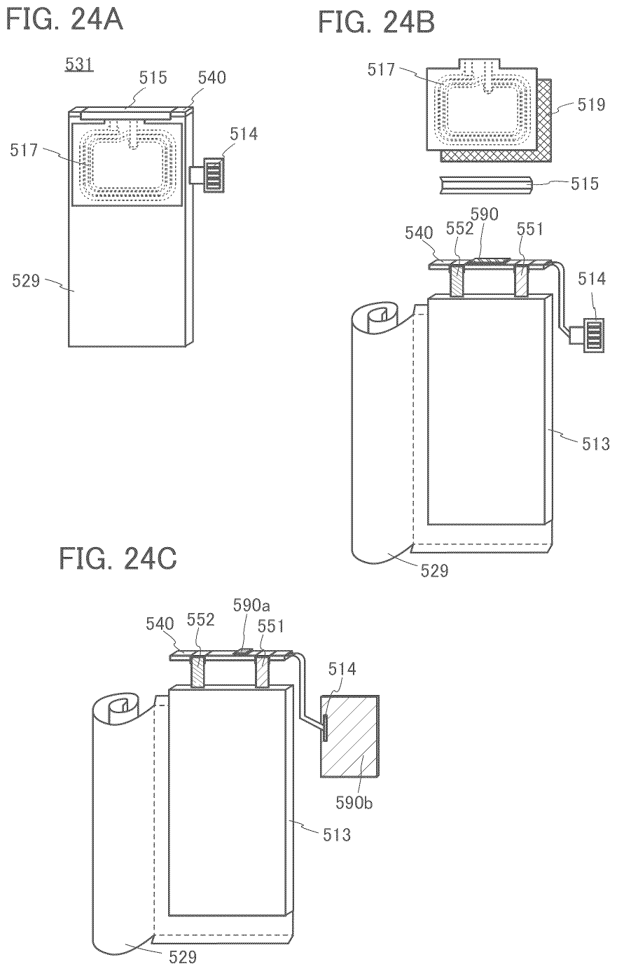

Examples of a secondary battery pack of one embodiment of the present invention that is capable of wireless charging using an antenna are described with reference to FIG. 24A to FIG. 24C.

FIG. 24A illustrates the appearance of a secondary battery pack 531 that has a rectangular solid shape with a small thickness (also referred to as a flat plate shape with a certain thickness). FIG. 24B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 24B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 24C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### [Negative Electrode]

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, and preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery including graphite can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄TisO₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li-MₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those for the conductive additive and the binder that can be included in the positive electrode active material layer can be used.

For the current collector, copper or the like can be used in addition to a material similar to that for the positive electrode current collector. Note that a material that is not alloyed with carrier ions of lithium or the like is preferably used for the negative electrode current collector.

### [Electrolyte Solution]

As one mode of the electrolyte 114, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂FsSO₂)₃, LiN(CF₃SO₂)₂, LiN(C₄F₉SO₂) (CF₃SO₂), LiN(C₂FsSO₂)₂, and lithium bis(oxalate)borate (Li(C₂O₄)₂, LiBOB) can be used, or two or more of these lithium salts can be used in an appropriate combination in an appropriate ratio.

The electrolyte solution used for the power storage device is preferably highly purified and contains a small amount of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound like succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained by swelling a polymer with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Separator]

The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Although a material in a glass state can be used as a ceramic material, the material preferably has a low electron conductivity, unlike the coating material 101 used for an electrode. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

The contents in this embodiment can be freely combined with the contents in the other embodiments.

### Embodiment 5

This embodiment will describe an example in which an all-solid-state battery is fabricated using the positive electrode active material composite 100z obtained in the foregoing embodiment.

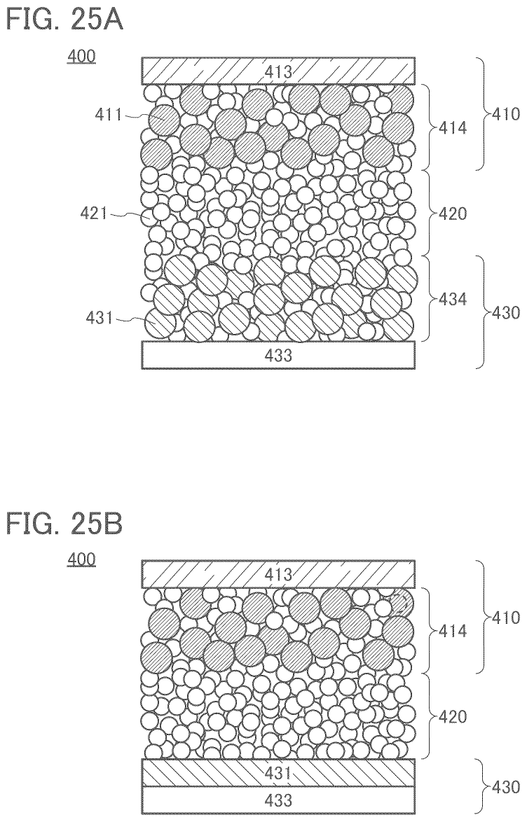

As illustrated in FIG. 25A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material composite 100z obtained in the foregoing embodiment is used for the positive electrode active material 411. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 25B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂Si₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-y}Al_{y}Ti_{2-y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

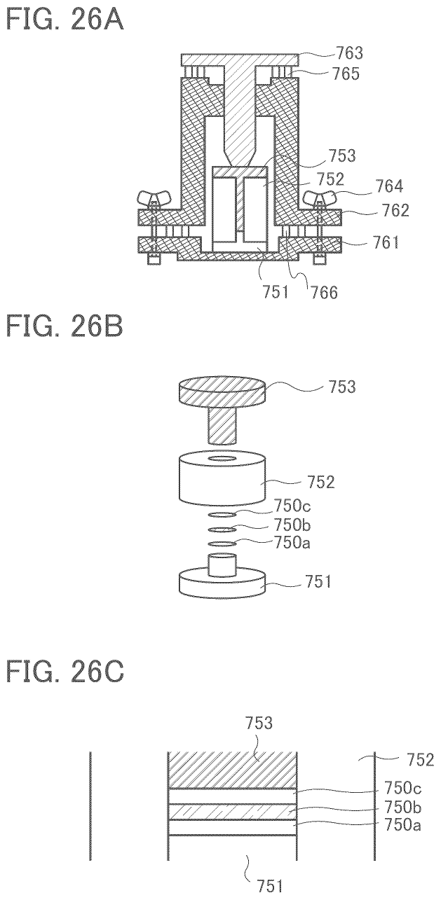

FIG. 26 illustrates an example of a cell for evaluating materials of an all-solid-state battery.

FIG. 26A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 26B is an enlarged perspective view of the evaluation material and its vicinity.

A stack of a positive electrode 750a, a solid electrolyte layer 750b, and a negative electrode 750c is illustrated as an example of the evaluation material, and its cross section is illustrated in FIG. 26C. Note that the same portions in FIG. 26A to FIG. 26C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

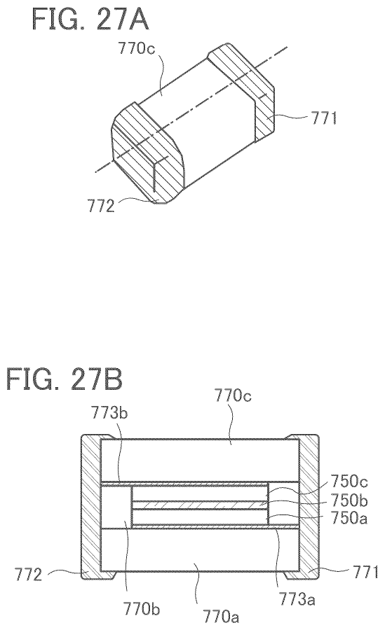

FIG. 27A is a perspective view of a secondary battery of one embodiment of the present invention that has an exterior body and a shape different from those in FIG. 26. The secondary battery in FIG. 27A includes external electrodes 771 and 772 and is sealed with an exterior body including a plurality of package components.

FIG. 27B illustrates an example of a cross section along the dashed-dotted line in FIG. 27A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material composite 100z described in the foregoing embodiment can achieve an all-solid-state secondary battery having a high energy density and favorable output characteristics.

The contents in this embodiment can be combined with the contents in the other embodiments as appropriate.

### Embodiment 6

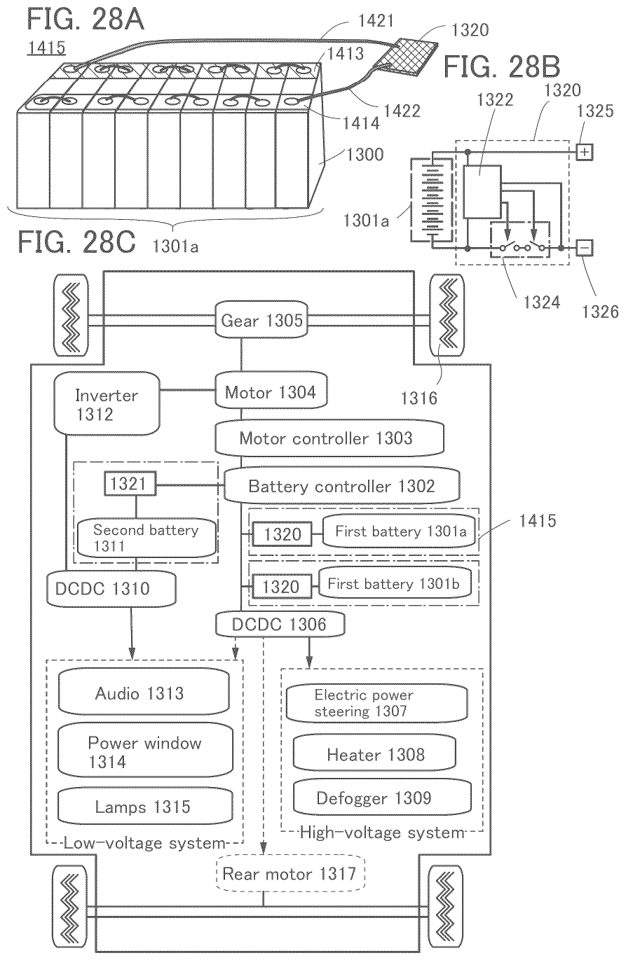

In this embodiment, an example in which a secondary battery different from the cylindrical secondary battery in FIG. 19D is used in an electric vehicle (EV) is described with reference to FIG. 28C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 20A or FIG. 21C or the stacked structure illustrated in FIG. 22A or FIG. 22B. Alternatively, the first battery 1301a may be the all-solid-state battery in Embodiment 5. Using the all-solid-state battery in Embodiment 5 as the first battery 1301a achieves high capacity, a high degree of safety, reduction in size, and reduction in weight.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DCDC circuit 1310.

The first battery 1301a will be described with reference to FIG. 28A.

FIG. 28A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the ratios of the numbers of In, Ga, and Zn atoms to the metal elements contained in the CAC-OS in an In—Ga—Zn oxide are denoted by [In], [Ga], and [Zn], respectively. For example, the first region in the CAC-OS in the In—Ga—Zn oxide has [In] higher than [In] in the composition of the CAC-OS film. Moreover, the second region has [Ga] higher than [Ga] in the composition of the CAC-OS film. Alternatively, for example, the first region has [In] higher than [In] in the second region and [Ga] lower than [Ga] in the second region. Moreover, the second region has [Ga] higher than [Ga] in the first region and [In] lower than [In] in the first region.

Specifically, the first region is a region including indium oxide, indium zinc oxide, or the like as its main component. The second region is a region including gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, in EDX mapping obtained by energy dispersive X-ray spectroscopy (EDX), it is confirmed that the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Ion), high field-effect mobility (μ), and favorable switching operation can be achieved.

An oxide semiconductor has various structures with different properties. Two or more kinds among the amorphous oxide semiconductor, the polycrystalline oxide semiconductor, the a-like OS, the CAC-OS, the nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C.; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery including a positive electrode using the positive electrode active material composite 100z obtained in the foregoing embodiment, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of the secondary battery include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charge and discharge; an uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the control circuit portion 1320 not only detects a micro-short circuit but also senses a terminal voltage of the secondary battery and controls the charge and discharge state of the secondary battery. For example, to prevent overcharge, the control circuit portion 1320 can turn off an output transistor of a charge circuit and an interruption switch substantially at the same time.

FIG. 28B is an example of a block diagram of the battery pack 1415 illustrated in FIG. 28A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+1N) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used. For example, the all-solid-state battery in Embodiment 5 may be used. Using the all-solid-state battery in Embodiment 5 as the second battery 1311 achieves high capacity, reduction in size and reduction in weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, an outlet of a charger or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charge can be performed with electric power supplied from external charge equipment by a contactless power feeding system or the like.

For fast charge, secondary batteries that can withstand high-voltage charge have been desired to perform charge in a short time.

The above-described secondary battery in this embodiment includes the positive electrode active material composite 100z obtained in the foregoing embodiment. Moreover, even when graphene is used as a conductive additive and the electrode layer is formed thick to increase the loading amount, it is possible to achieve a secondary battery with significantly improved electrical characteristics while synergy such as a reduction in capacity and the retention of high capacity can be obtained. This secondary battery is particularly effectively used in a vehicle and can achieve a vehicle that has a long range, specifically a driving range per charge of 500 km or longer, without increasing the proportion of the weight of the secondary battery to the weight of the entire vehicle.

Specifically, in the above-described secondary battery in this embodiment, the use of the positive electrode active material composite 100z described in the foregoing embodiment can increase the operating voltage of the secondary battery, and the increase in charge voltage can increase the available capacity. Moreover, using the positive electrode active material composite 100z described in the foregoing embodiment in the positive electrode can provide an automotive secondary battery having excellent charge and discharge cycle performance.

Next, examples in which the secondary battery of one embodiment of the present invention is mounted on a vehicle, typically a transport vehicle, will be described.

Mounting the secondary battery illustrated in any of FIG. 19D, FIG. 21C, and FIG. 28A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

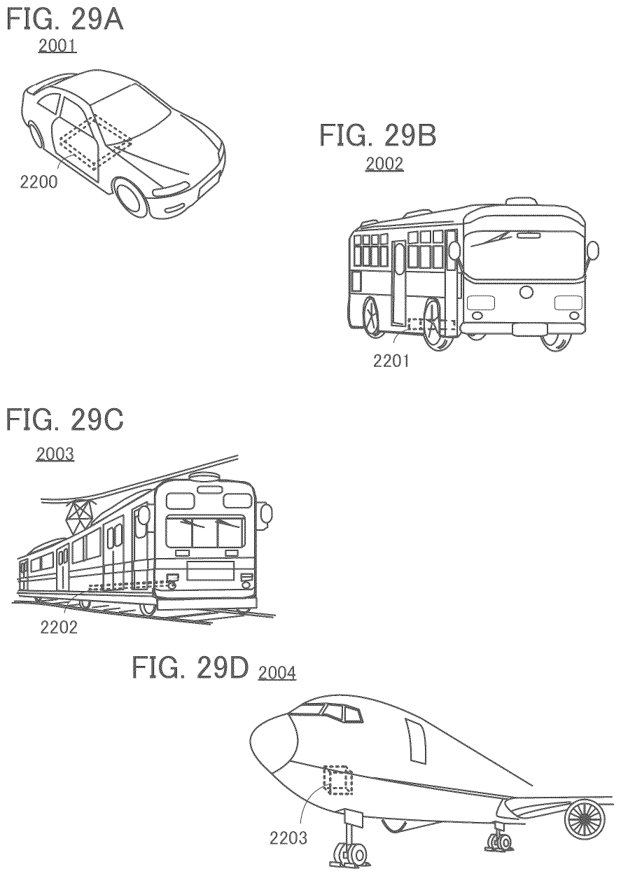

FIG. 29A to FIG. 29D illustrate examples of transport vehicles as one example of vehicles using one embodiment of the present invention. An automobile 2001 illustrated in FIG. 29A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 29A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charge equipment through a plug-in system, a contactless charge system, or the like. In charging, a given method such as CHAdeMO (registered trademark) or Combined Charging System may be employed as a charge method, the standard of a connector, and the like as appropriate. The secondary battery may be a charge station provided in a commerce facility or a household power supply. For example, a plug-in technique enables an exterior power supply to charge a power storage device incorporated in the automobile 2001. The charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 29B illustrates a large transporter 2002 having a motor controlled by electric power, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 29A except, for example, the number of secondary batteries forming the secondary battery module of the battery pack 2201 or the like is different; thus the description is omitted.

FIG. 29C illustrates a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. With the use of the positive electrode using the positive electrode active material composite 100z described in the foregoing embodiment, a secondary battery having favorable rate characteristics and charge and discharge cycle performance can be fabricated, which can contribute to higher performance and a longer life of the transport vehicle 2003. A battery pack 2202 has a function similar to that in FIG. 29A except that the number of secondary batteries forming the secondary battery module of the battery pack 2202 or the like is different; thus, the detailed description is omitted.

FIG. 29D illustrates an aircraft 2004 having a combustion engine as an example. The aircraft 2004 illustrated in FIG. 29D can be regarded as a kind of transport vehicle since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 29A except, for example, the number of secondary batteries forming the secondary battery module of the battery pack 2203; thus the detailed description is omitted.

The contents in this embodiment can be combined with the contents in the other embodiments as appropriate.

### Embodiment 7

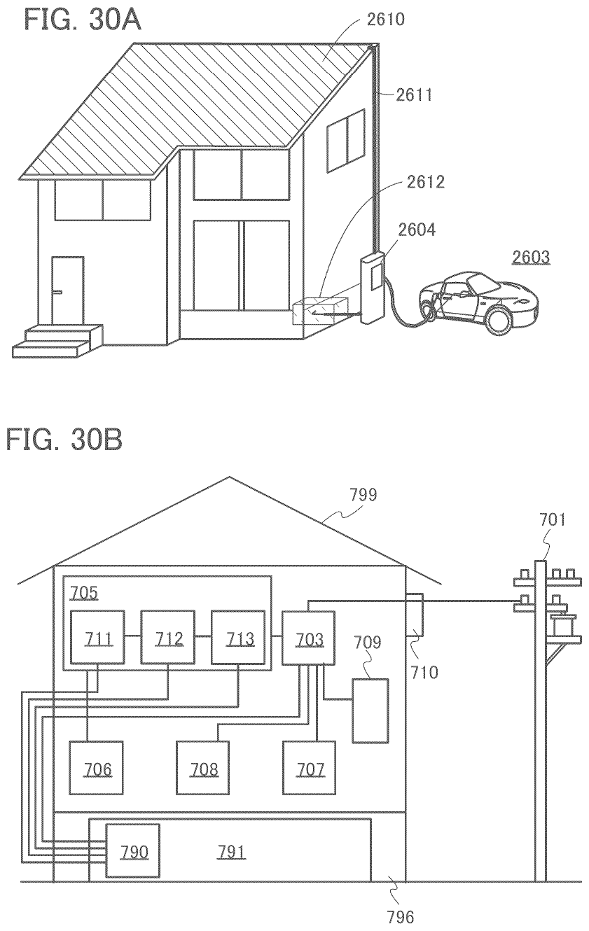

In this embodiment, examples in which the secondary battery of one embodiment of the present invention is mounted on a building will be described with reference to FIG. 30A and FIG. 30B.

A house illustrated in FIG. 30A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charge equipment 2604. The power storage device 2612 can be charged with electric power generated by the solar panel 2610. The secondary battery included in the vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 30B illustrates an example of a power storage device of one embodiment of the present invention. As illustrated in FIG. 30B, a power storage device 791 of one embodiment of the present invention is provided in an underfloor space 796 of a building 799. The power storage device 791 may be provided with the control circuit described in Embodiment 6, and the use of a secondary battery including a positive electrode using the positive electrode active material composite 100z obtained in the foregoing embodiment for the power storage device 791 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 8

This embodiment will describe examples in which the power storage device of one embodiment of the present invention is mounted on a motorcycle and a bicycle.

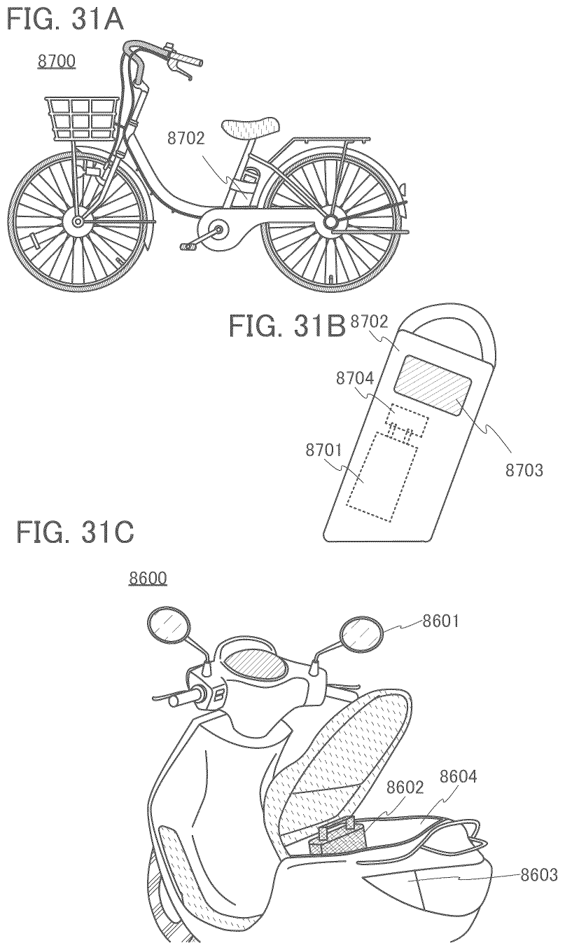

FIG. 31A illustrates an example of an electric bicycle using the power storage device of one embodiment of the present invention. The power storage device of one embodiment of the present invention can be used for an electric bicycle 8700 illustrated in FIG. 31A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 31B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may include the small solid-state secondary battery illustrated in FIG. 27A and FIG. 27B. When the small solid-state secondary battery illustrated in FIG. 27A and FIG. 27B is provided in the control circuit 8704, electric power can be supplied to store data in a memory circuit included in the control circuit 8704 for along time. When the control circuit 8704 is used in combination with a secondary battery including a positive electrode using the positive electrode active material composite 100z obtained in the foregoing embodiment, the synergy on safety can be obtained. The secondary battery including the positive electrode using the positive electrode active material composite 100z obtained in the foregoing embodiment and the control circuit 8704 can contribute greatly to elimination of accidents due to secondary batteries, such as fires.

FIG. 31C illustrates an example of a motorcycle using the power storage device of one embodiment of the present invention. A motor scooter 8600 illustrated in FIG. 31C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material composite 100z obtained in the foregoing embodiment can have high capacity and contribute to a reduction in size.

In the motor scooter 8600 illustrated in FIG. 31C, the power storage device 8602 can be stored in an under-seat storage unit 8604. The power storage device 8602 can be stored in the under-seat storage unit 8604 even when the under-seat storage unit 8604 is small.

The contents in this embodiment can be combined with the contents in the other embodiments as appropriate.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book terminal, and a mobile phone.

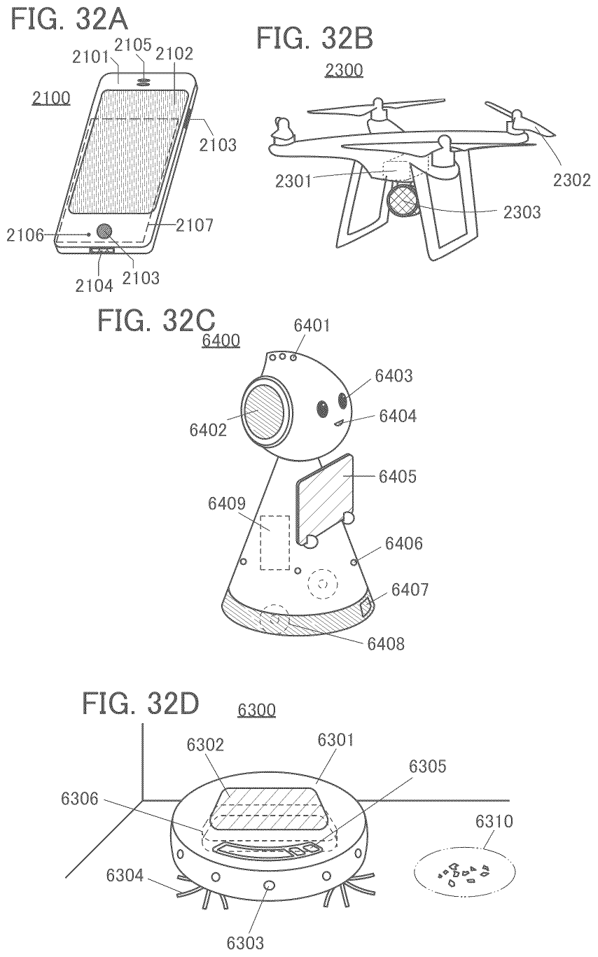

FIG. 32A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material composite 100z described in the foregoing embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 32B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material composite 100z obtained in the foregoing embodiment has high energy density and a high degree of safety, and thus can be used safely for a long time over a long period of time and is suitable as the secondary battery included in the unmanned aircraft 2300.

FIG. 32C illustrates an example of a robot. A robot 6400 illustrated in FIG. 32C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material composite 100z obtained in the foregoing embodiment has high energy density and a high degree of safety, and thus can be used safely for a long time over a long period of time and is suitable as the secondary battery 6409 included in the robot 6400.

FIG. 32D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material composite 100z obtained in the foregoing embodiment has high energy density and a high degree of safety, and thus can be used safely for a long time over a long period of time and is suitable as the secondary battery 6306 included in the cleaning robot 6300.

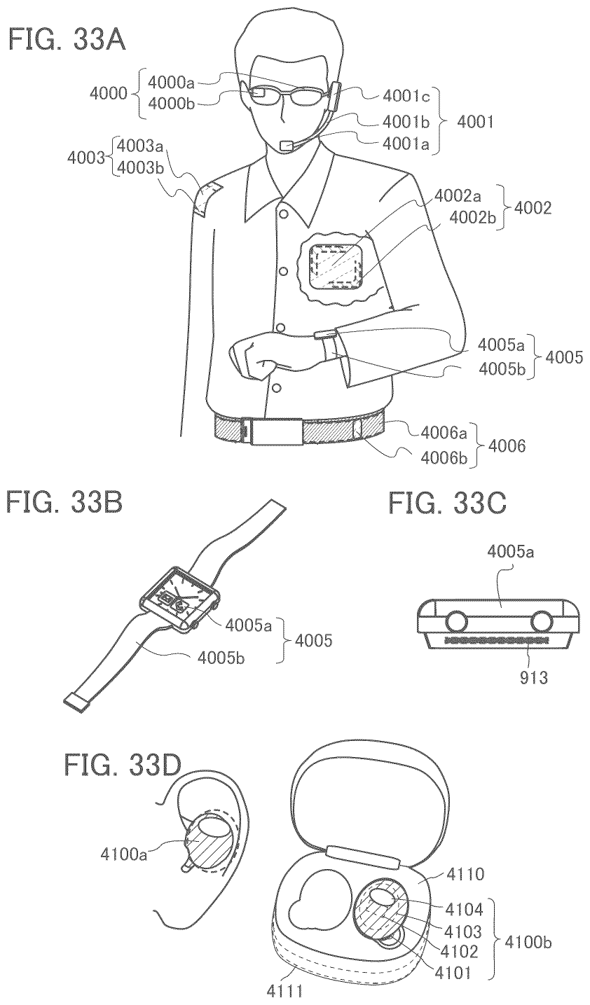

FIG. 33A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 as illustrated in FIG. 33A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material composite 100z obtained in the foregoing embodiment has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 33B is a perspective view of the watch-type device 4005 that is detached from an arm.

FIG. 33C is a side view. FIG. 33C illustrates a state where the secondary battery 913 is incorporated in the inner region. The secondary battery 913 is the secondary battery described in Embodiment 4. The secondary battery 913 is provided to overlap the display portion 4005a, can have high density and high capacity, and is small and lightweight.

Since the secondary battery in the watch-type device 4005 is required to be small and lightweight, the use of the positive electrode active material composite 100z obtained in the foregoing embodiment in the positive electrode of the secondary battery 913 enables the secondary battery 913 to have high energy density and a small size.

FIG. 33D illustrates an example of wireless earphones. The wireless earphones illustrated as an example consist of, but not limited to, a pair of main bodies 4100a and 4100b.

Each of the main bodies 4100a and 4100b includes a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charge, and the like. Each of the main bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material composite 100z obtained in the foregoing embodiment has a high energy density; thus, with the use of the secondary battery as the secondary battery 4103 and the secondary battery 4111, space saving required with downsizing of the wireless earphones can be achieved.

This embodiment can be implemented in appropriate combination with the other embodiments.

### Example 1

In this example, the positive electrode active material composite 100z in which a positive electrode active material and acetylene black were subjected to a composing process was formed and the electrode density was evaluated.

As the positive electrode active material, commercially available lithium cobalt oxide (Cellseed C-ION produced by NIPPON CHEMICAL INDUSTRIAL CO., LTD.) including cobalt as the transition metal M1 and not containing any additive element was prepared. Acetylene black (AB) was prepared as a conductive material, and polyvinylidene fluoride (PVDF) was prepared as a binder. As a solvent, NMP was prepared.

Next, a composing process of the lithium cobalt oxide and the acetylene black was performed to form a positive electrode active material composite. In the composing process, Picobond produced by Hosokawa Micron Ltd. was used, the operation conditions are 3500 rpm for 10 minutes, and the throughput was 50 g. The mixture ratio of the lithium cobalt oxide and the acetylene black was set to LCO:AB=95:3 (weight ratio).

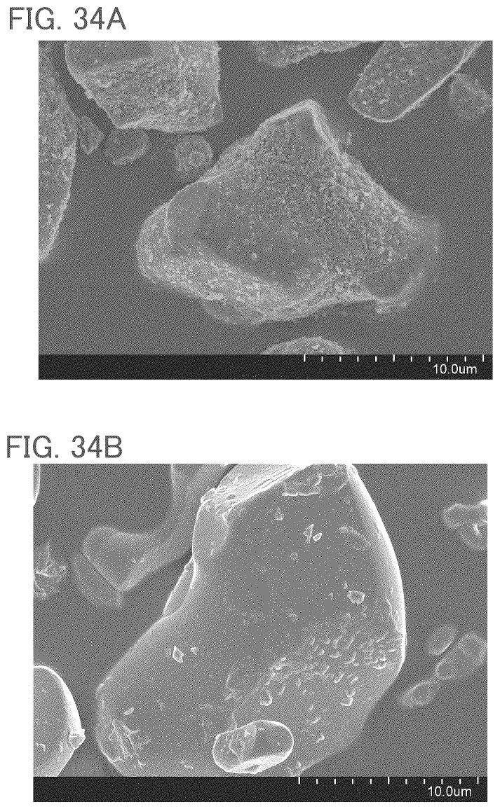

FIG. 34A shows a SEM image of the positive electrode active material composite. It was observed that part of the lithium cobalt oxide surface is covered with acetylene black. For comparison, FIG. 34B shows a SEM image of lithium cobalt oxide not subjected to the composing process. In the SEM observation in this example, an SU8030 scanning electron microscope produced by Hitachi High-Tech Corporation was used under the measurement conditions where the acceleration voltage was 5 kV and the magnification was 5000 times.

Next, an electrode layer with a length of 12 cm and a width of 4 cm was formed in the following manner: the positive electrode active material composite and PVDF dissolved in NMP were mixed to form a slurry, and the slurry was applied to a positive electrode current collector and dried. A 20-μm aluminum foil was used as the positive electrode current collector.

Next, pressure was applied on the electrode layer with a calender roll to form a positive electrode. The pressure application was performed on the electrode layer with a width of 4 cm at 210 kN/m, 461 kN/m, 964 kN/m, and 1467 kN/m in this order. The thickness of the positive electrode was measured at nine positions by a micrometer at each pressure, and the thickness of the electrode layer was obtained by subtracting the thickness of the current collector from the thickness of the positive electrode. Lastly, the electrode layer was cut into nine positive electrodes with a diameter of 12 mm each including any one of the measured nine positions. The weight of each of the positive electrodes was measured, and the weight of each of the electrode layers was obtained by subtracting the weight of the current collector therefrom. The electrode density was obtained from the thickness at each pressure, area, and weight of the electrode layer, and the average value was calculated.

As a comparative example, a slurry was formed using the lithium cobalt oxide not subjected to the composing process, the acetylene black, PVDF, and the solvent. The mixture ratio thereof was set to lithium cobalt oxide:AB:PVDF=95:3:2 (weight ratio). NMP was used as the solvent. The slurry was applied to a positive electrode current collector, dried, and pressed in a manner similar to the above so that the electrode density was calculated.

Table 1 shows the formation conditions of the positive electrode using the positive electrode active material composite and the positive electrode using the lithium cobalt oxide not subjected to the composing process.

TABLE 1

| | LCO:AB:PVDF | |
|---|---|---|
| | (weight ratio) | Timing of AB coating/mixing |
| With composing | 95:3:2 | Only when performing |
| process | | composing process |
| Without composing | | Only when forming slurry |
| process | | |
| (comparison example) | | |

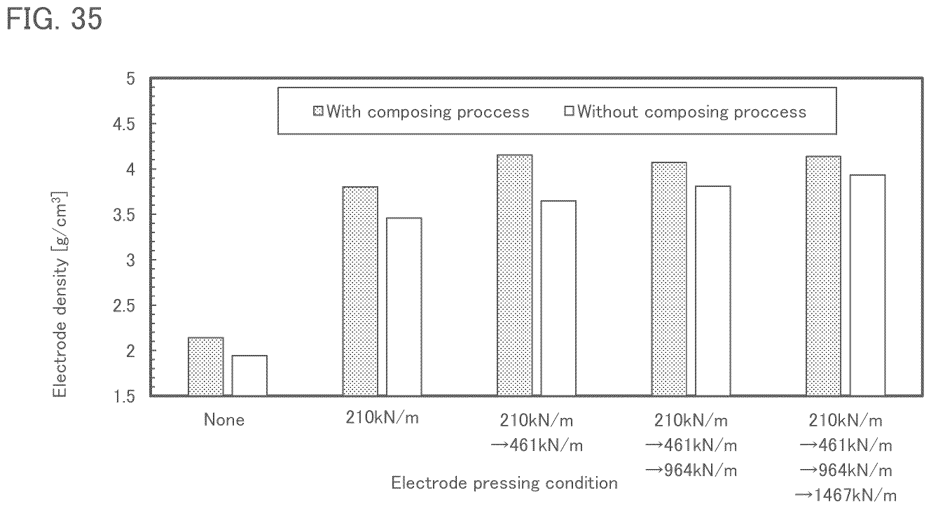

FIG. 35 is a graph showing the average value of the calculated electrode density. The electrode density of the positive electrode using the positive electrode active material composite was able to be increased at lower pressure than that of the comparative example. Specifically, the electrode density was able to be 3.80 g/cc when pressure was applied at 210 kN/m. In addition, the highest point of the electrode density of the positive electrode using the positive electrode active material composite is higher than that of the comparative example such that the maximum value was 4.15 g/cc when pressure was applied at 210 kN/m and 461 kN/m.

### Example 2

In this example, the positive electrode active material composite 100z was formed in which the positive electrode active material and graphene oxide were subjected to a composing process by wet mixing, and the charge and discharge characteristics were evaluated.

### <Formation of Positive Electrode Active Material>

First, a positive electrode active material containing cobalt as the transition metal M1, which is obtained through heating after addition of magnesium, fluorine, nickel, and aluminum was formed in the following manner.

Commercially available lithium cobalt oxide (Cellseed C-ION produced by NIPPON CHEMICAL INDUSTRIAL CO., LTD.) including cobalt as the transition metal M1 and not containing any additive element was prepared.

Next, a magnesium source, a fluorine source, a nickel source, and an aluminum source were prepared as additive element sources.

Specifically, LiF was prepared as the fluorine source, and MgF₂ was prepared as the fluorine source and the magnesium source. LiF and MgF₂ were weighed so that LiF:MgF₂=1:3 (molar ratio). Then, LiF and MgF₂ were mixed into dehydrated acetone and the mixture was stirred at a rotating speed of 400 rpm for 12 hours, whereby an additive element source X_{A} was produced. Then, the mixture was made to pass through a sieve with an aperture of 300 m, whereby the additive element source X_{A} having a uniform particle diameter was obtained.

Ni(OH)₂ was prepared as the nickel source. Similarly, stirring was performed at a rotating speed of 400 rpm for 12 hours using the dehydrated acetone as a solvent, and then the mixture was made to pass through a sieve, whereby an additive element source X_{Ni} having a uniform particle diameter was obtained.

Al(OH)₃ was prepared as the aluminum source. Similarly, stirring was performed at a rotating speed of 400 rpm for 12 hours using the dehydrated acetone as a solvent, and then the mixture was made to pass through a sieve, whereby an additive element source X_{A1} having a uniform particle diameter was obtained.

Next, the additive element source X_{A}, the additive element source X_{Ni}, and the additive element source X_{A1} were weighed to be 1 at %, 0.5 at %, and 0.5 at % of the transition metal M1, respectively, and were mixed with the lithium cobalt oxide by a drying process. At this time, stirring was performed at a rotating speed of 1500 rpm for 1.5 minutes. These conditions were milder than those of the stirring in the production of the additive element source X_{A}. Finally, the mixture was made to pass through a sieve with an aperture of 300 m, whereby a mixture A having a uniform particle diameter was obtained.

Then, the mixture A was heated. With the use of a muffle furnace, heating was performed three times at 900° C. for 10 hours. During the heating, a lid was put on the crucible containing the mixture A. The atmosphere in the muffle furnace was an oxygen atmosphere with an oxygen flow rate of 10 L/min. During the three-time heating, the mixture A was taken out from the muffle furnace and crushed with a mortar and a pestle. By the heating, a positive electrode active material containing magnesium, fluorine, nickel, and aluminum was obtained.

### <Formation of Positive Electrodes>

Positive electrodes were formed using the positive electrode active material formed in the above manner. As a material of a conductive material, graphene oxide (GO) or acetylene black (AB) was prepared. As a binder, polyvinylidene fluoride (PVDF) was used. As a solvent, a mixture of NMP or ethanol and water at 7:3 (volume ratio) was prepared. A 20-μm aluminum foil was prepared as a current collector.

The positive electrode using graphene oxide as the material of the conductive material was formed in the following manner. First, dried graphene oxide was weighed and mixed with a solvent. NMP was used as the solvent. The positive electrode active material and the binder are added to the mixture in this order and mixed to form a slurry. The slurry was applied to the current collector and dried, so that an electrode layer was formed. Note that the mixing ratio of the electrode layer was set to positive electrode active material: GO:binder=97:1:2.

First, chemical reduction was performed on the electrode layer. An aqueous solution in which ascorbic acid of 0.075 mol/L and lithium hydroxide of 0.074 mol/L were dissolved was prepared. The aqueous solution and NMP were mixed at a volume ratio of 1:9 and kept at 60° C., and the electrode layer was immersed in the mixed solution for 1 hour. Then, the electrode layer is cleaned.

Next, thermal reduction was performed on the electrode layer. Specifically, with the use of a vacuum dryer, heating was performed at 170° C. for 10 hours.

By performing reduction treatment, the graphene oxide (GO) in the electrode layer changes to reduced graphene oxide (RGO) and obtain conductivity. Performing chemical reduction before thermal reduction as described above can sufficiently reduce graphene oxide when the temperature of the thermal reduction is lowered, so that deterioration of PVDF of the binder can be prevented.

The positive electrode using acetylene black as a conductive material was formed in the following manner. The positive electrode active material, acetylene black (AB), PVDF, and NMP were mixed to form a slurry. The slurry was applied to the current collector and dried, so that an electrode layer was formed. Note that the mixing ratio of the electrode layer was set to positive electrode active material: acetylene black:binder=95:3:2.

Table 2 shows the formation conditions of the two kinds of positive electrodes.

TABLE 2

| Positive | Positive electrode active | Material of conductive | | LCO:conductive material:PVDF |
|---|---|---|---|---|
| electrode | material | material | Reduction process | Mixing condition (weight ratio) |
| GO | LCO containing | Graphene oxide | Chemical reduction→ | 97:1:2 |
| | Mg, F, Ni, and Al | | Thermal reduction | |
| AB | | Acetylene black | — | 95:3:2 |

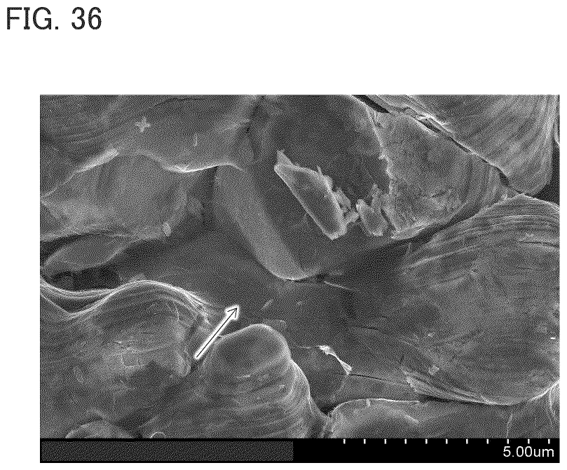

FIG. 36 shows a surface SEM image of the electrode containing reduced graphene oxide (RGO) as the material of the conductive material. As indicated by the arrow in the diagram, the reduced graphene oxide covering the surface of the positive electrode active material in a large area was confirmed.

### <Charge and Discharge Characteristics>

Using the above two kinds of positive electrodes, coin cells were fabricated.

As an electrolyte solution, a solution which is obtained by adding vinylene carbonate (VC) at 2 wt % as an additive to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. As a separator, polypropylene was used.

A lithium metal was prepared as a counter electrode to fabricate coin-type half cells including the above positive electrodes and the like, and rate characteristics and cycle performance were measured.

Here, a discharge rate and a charge rate are described. The discharge rate refers to the relative ratio of a current at the time of discharge to battery capacity and is expressed in a unit C. A current corresponding to 1 C in a battery with a rated capacity X(Ah) is X(A). The case where discharge is performed with a current of 2X (A) is rephrased as to perform discharge at 2 C, and the case where discharge is performed with a current of X/5 (A) is rephrased as to perform discharge at 0.2 C. The same applies to the charge rate; the case where charge is performed with a current of 2X (A) is rephrased as to perform charging at 2 C, and the case where charge is performed with a current of X/5 (A) is rephrased as to perform charge at 0.2 C. In this example, 1 C was 200 mA/g.

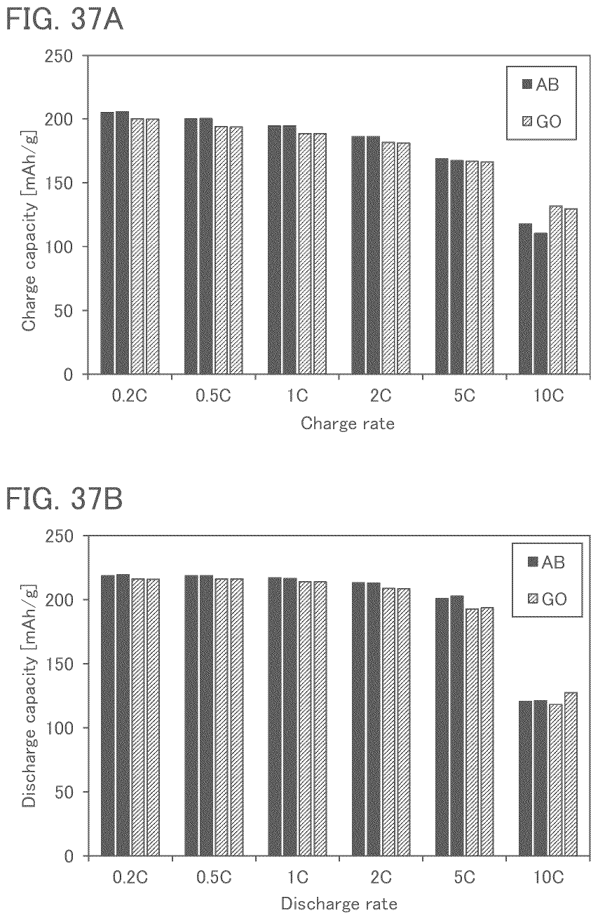

The rate characteristics were measured as follows. In the evaluation of the charge rate, CC (each rate, termination voltage of 4.6 V) was employed as a charge method, and CC (0.2 C, termination voltage of 2.5 V) was employed as a discharge method. In the evaluation of the discharge rate, CC/CV (0.2 C, 4.6 V, termination current of 0.02 C) was employed as a charge method, and CC (each rate, termination voltage of 2.5 V) was employed as a discharge method. The measurement temperatures for both cases were set to 25° C. FIG. 37A shows charge capacity at 0.2 C, 0.5 C, 1 C, 2 C, 5 C, and 10 C. FIG. 37B shows discharge capacity at 0.2 C, 0.5 C, 1 C, 2 C, 5 C, and 10 C. Here, n=2.

As shown in FIG. 37A and FIG. 37B, in charge and discharge at a high rate such as at 10 C, the positive electrode containing the reduced graphene oxide (RGO) as the material of the conductive material showed more favorable rate characteristics.

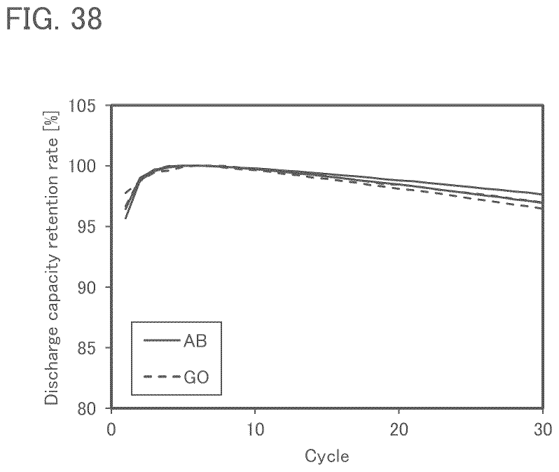

In the measurement of the cycle performance, (0.5 C, 4.6 V, termination current of 0.05 C) was employed as a charge method, and CC (0.5 C, termination voltage of 2.5 V) was employed as a discharge method. The measurement temperature was set to 45° C. FIG. 38 is a graph showing the cycle performance. Here, n=2.

As shown in FIG. 38, the positive electrode using acetylene black as the material of the conductive material showed relatively favorable cycle performance compared with the positive electrode including the reduced graphene oxide (RGO) as the conductive material; however, a significant difference was not observed.

### REFERENCE NUMERALS

100: positive electrode active material, 100x: first active material, 100xa: first active material, 100xb: first active material, 100y: second active material, 100z: positive electrode active material composite, 101: coating material, 102: graphene compound, 103: carbon black, 114: electrolyte, 1101: positive electrode, 1104: positive electrode current collector, 1105: positive electrode active material layer

1. A positive electrode comprising:
a first active material;
a second active material; and
glass,
wherein at least part of a surface of the first active material comprises a region covered with the glass,
wherein at least part of a surface of the glass comprises a region covered with the second active material,
wherein the first active material comprises a first composite oxide represented by LiM1O₂, M1 being one or more selected from Fe, Ni, Co, and Mn,
wherein the second active material comprises a second composite oxide represented by LiM2PO₄, M2 being one or more selected from Fe, Ni, Co, and Mn, and
wherein the glass has lithium-ion conductivity.

2. A positive electrode comprising:
a first active material;
a second active material; and
glass,
wherein at least part of a surface of the first active material comprises a region covered with the glass and the second active material,
wherein the first active material comprises a first composite oxide represented by LiM1O₂, M1 being one or more selected from Fe, Ni, Co, and Mn,
wherein the second active material comprises a second composite oxide represented by LiM2PO₄, M2 being one or more selected from Fe, Ni, Co, and Mn, and
wherein the glass has lithium-ion conductivity.

3. The positive electrode according to claim 1, further comprising a conductive material,
wherein at least part of a surface of the second active material comprises a region covered with the conductive material, and
wherein the conductive material comprises a graphene compound or carbon nanotube.

4. The positive electrode according to claim 3,
wherein at least part of a surface of the glass comprises a region covered with the conductive material.

5. The positive electrode according to claim 1,
wherein the first active material comprises lithium cobalt oxide comprising magnesium, fluorine, aluminum, and nickel, and
wherein the lithium cobalt oxide comprises a region with the highest concentration of any one or more selected from the magnesium, the fluorine, and the aluminum in a surface portion.

6-12. (canceled)

13. A method for forming a positive electrode, comprising:
performing a composing process of lithium cobalt oxide comprising magnesium, fluorine, aluminum, a nickel and acetylene black to form a positive electrode active material composite;
mixing the positive electrode active material composite, a binder, and a solvent to form a slurry;
applying the slurry to a positive electrode current collector to form an electrode layer; and
pressing the electrode layer.

14. A method for forming a positive electrode, comprising:
mixing lithium cobalt oxide comprising magnesium, fluorine, aluminum, and nickel, graphene oxide, a binder, and a solvent to form a slurry;
applying the slurry to a positive electrode current collector to form an electrode layer; and
subjecting the electrode layer to chemical reduction and thermal reduction.

15. The method for forming a positive electrode according to claim 14,
wherein the chemical reduction is a step of immersing the electrode layer in an ascorbic acid aqueous solution, and
wherein the thermal reduction is a step of heating the electrode layer at higher than or equal to 125° C. and lower than or equal to 200° C.

16. The positive electrode according to claim 2, further comprising a conductive material,
wherein at least part of a surface of the first active material comprises a region covered with the glass, the second active material, and the conductive material, and
wherein the conductive material comprises a graphene compound or carbon nanotube.

17. The positive electrode according to claim 2,
wherein the first active material comprises lithium cobalt oxide comprising magnesium, fluorine, aluminum, and nickel, and
wherein the lithium cobalt oxide comprises a region with the highest concentration of any one or more selected from the magnesium, the fluorine, and the aluminum in a surface portion.
